(19) United States
(12) Patent Application Publication
(10) Pub. No.: US 2024/0280084 A1
(43) Pub. Date: Aug. 22, 2024

(54) SYSTEMS AND METHODS FOR MONITORING WIND TURBINES USING WIND TURBINE COMPONENT VIBRATION DATA

(71) Applicant: Utopus Insights, Inc., Valhalla, NY (US)

(72) Inventors: Xueyin Yu, White Plains, NY (US); Kim Fluchel, Pittstown, NJ (US)

(73) Assignee: Utopus Insights, Inc., Valhalla, NY (US)

(21) Appl. No.: 18/444,409

(22) Filed: Feb. 16, 2024

Related U.S. Application Data
(60) Provisional application No. 63/485,431, filed on Feb. 16, 2023.

(51) Int. Cl. F03D 17/00; G01M 7/02; G08B 21/18

(52) U.S. Cl. CPC F03D 17/015; F03D 17/007; G01M 7/025; G08B 21/18; F05B 2260/83

(57) ABSTRACT

An example method includes receiving time-series vibration data for multiple components of multiple wind turbines. Based on the time-series vibration data, multiple groups of wind turbines are defined, as well as first and second vibration thresholds for each group. Time-series vibration data for a component of a particular wind turbine is received. A particular group that includes the particular wind turbine, as well as particular first and second vibration thresholds are identified. A vibration of the component has exceeded the particular first vibration threshold is determined. A forecast of at least one of a period of time before the vibration may exceed the particular second vibration threshold and a future date at which the vibration may exceed the particular second vibration threshold is generated. An alert that includes the particular wind turbine and at least one of the period of time and the future date is generated and provided.

### CROSS-REFERENCE TO RELATED APPLICATION

This application claims priority to U.S. Provisional Patent Application No. 63/485,431, filed on Feb. 16, 2023, and entitled “CONDITION MONITORING AND PREDICTIVE MAINTENANCE,” which is incorporated in its entirety herein by reference.

### FIELD OF THE INVENTION(S)

Embodiments of the present invention(s) are generally related to monitoring wind turbines, and in particular, to monitoring wind turbines using wind turbine component vibration data.

### BACKGROUND

The global operation and maintenance market for wind turbines is expected to grow at a compound annual growth rate (CAGR) of 16% and reach $5.8 billion (€5.5 billion) by 2029. Wind turbines have numerous sensors that generate large amounts of data every day. Data from supervisory control and data acquisition (SCADA) systems with machine learning (ML) techniques may be utilized to detect faults and predict failure for wind turbine components and failure modes throughout wind turbine drivetrains. However, SCADA data, such as temperature data and pressure measurement data, typically changes slowly. The slow rate of change of SCADA data may result in SCADA data being not useful for early detection of potential problems.

### SUMMARY

An example non-transitory computer-readable medium may comprise executable instructions. The executable instructions may be executable by one or more processors to perform a method comprising: receiving multiple first sets of time-series vibration data for multiple wind turbines, each first set of time-series vibration data for a component of a wind turbine of the multiple wind turbines, defining, based on the multiple first sets of time-series vibration data, multiple groups of wind turbines of the multiple wind turbines, each group including two or more wind turbines of the multiple wind turbines, for each group of the multiple groups of wind turbines, defining, based on a subset of the multiple first sets of time-series vibration data for the components of the two or more wind turbines included in the group, a first vibration threshold and a second vibration threshold, receiving multiple second sets of time-series vibration data for a particular wind turbine of the multiple wind turbines, each second set of time-series vibration of the component of the particular wind turbine, identifying a particular group that includes the particular wind turbine, identifying, based on the particular group, a particular first vibration threshold and a particular second vibration threshold, determining, based on the multiple second sets of time-series vibration data, that a vibration of the component of the particular wind turbine has exceeded the particular first vibration threshold, generating a forecast of at least one of a period of time before the vibration of the component of the particular wind turbine may exceed the particular second vibration threshold and a future date at which the vibration of the component of the particular wind turbine may exceed the particular second vibration threshold, generating an alert, the alert including the particular wind turbine and at least one of the period of time and the future date, and providing the alert.

The method may further comprise controlling, based on the alert, the particular wind turbine. In some embodiments, each first set of time-series vibration data includes time-series vibration data for a period of time following a servicing of the component of the wind turbine of the multiple wind turbines. In various embodiments, defining, based on the subset of the multiple first sets of time-series vibration data for the components of the two or more wind turbines included in the group, the first vibration threshold and the second vibration threshold comprises, for each group of the multiple groups of wind turbines, defining, based on a mean and a standard deviation of the subset of the multiple first sets of time-series vibration data for the components of the two or more wind turbines included in the group, the first vibration threshold.

Each first set of time-series vibration data may include time-series vibration data for a period of time prior to a servicing of the component of the wind turbine of the multiple wind turbines or a failure of the component of the wind turbine of the multiple wind turbines. In some embodiments, defining, based on the subset of the multiple first sets of time-series vibration data for the components of the two or more wind turbines included in the group, the first vibration threshold and the second vibration threshold comprises, for each group of the multiple groups of wind turbines, defining, based on a mean of the subset of the multiple first sets of time-series vibration data for the period of time prior to the servicing of the component of the wind turbine of the multiple wind turbines or the failure of the component of the wind turbine of the multiple wind turbines for the components of the two or more wind turbines included in the group, the second vibration threshold.

The method may further comprise determining, based on the multiple second sets of time-series vibration data, a trend for the vibration of the component of the particular wind turbine and determining an error for the vibration of the component of the particular wind turbine, wherein generating the forecast of at least one of the period of time before the vibration of the component of the particular wind turbine may exceed the particular second vibration threshold and the future date at which the vibration of the component of the particular wind turbine may exceed the particular second vibration threshold includes generating, based on the trend of the vibration for the particular wind turbine and the error for the vibration of the component of the particular wind turbine, the forecast of at least one of the period of time before the vibration of the component of the particular wind turbine may exceed the particular second vibration threshold and the future date at which the vibration of the component of the particular wind turbine may exceed the particular second vibration threshold. In some embodiments, the method may further comprise determining, based on the multiple first sets of time-series vibration data for the multiple wind turbines, at least one of periodic changes and short-term changes in vibrations of the components of the multiple wind turbines, wherein generating the forecast of at least one of the period of time before the vibration of the component of the particular wind turbine may exceed the particular second vibration threshold and the future date at which the vibration of the component of the particular wind turbine may exceed the particular second vibration threshold further includes generating, based on at least one of the periodic changes and the short-term changes in vibrations of the components of the multiple wind turbines, the forecast of at least one of the period of time before the vibration of the component of the particular wind turbine may exceed the particular second vibration threshold and the future date at which the vibration of the component of the particular wind turbine may exceed the particular second vibration threshold.

Defining, based on the multiple first sets of time-series vibration data, the multiple groups of wind turbines of the multiple wind turbines, may include defining, based on mean, one or more standard deviations, and one or more percentiles of the multiple first sets of time-series vibration data, the multiple groups of wind turbines of the multiple wind turbines.

In some embodiments, the method further comprising generating, based on the multiple first sets of time-series vibration data, multiple multidimensional features for the multiple wind turbines based on mean, one or more standard deviations, and one or more percentiles of the multiple first sets of time-series vibration data, wherein defining, based on the multiple first sets of time-series vibration data, the multiple groups of wind turbines of the multiple wind turbines, includes: clustering the multiple wind turbines, based on the multiple multidimensional features for the multiple wind turbines, to obtain multiple clusters of wind turbines, each cluster including two or more wind turbines of the multiple wind turbines, and creating the multiple groups of wind turbines of the multiple wind turbines based on the multiple clusters of wind turbines.

The method may further comprise receiving an indication that a servicing of the component of the particular wind turbine has been performed, receiving multiple third sets of time-series vibration data for the particular wind turbine, each third set of time-series vibration data for the component of the particular wind turbine, and based on the multiple third sets of time-series vibration data, placing the particular wind turbine in a group different from the particular group that included the particular wind turbine prior to the servicing of the component of the particular wind turbine.

An example method may comprise receiving multiple first sets of time-series vibration data for multiple wind turbines, each first set of time-series vibration data for a component of a wind turbine of the multiple wind turbines, defining, based on the multiple first sets of time-series vibration data, multiple groups of wind turbines of the multiple wind turbines, each group including two or more wind turbines of the multiple wind turbines, for each group of the multiple groups of wind turbines, defining, based on a subset of the multiple first sets of time-series vibration data for the components of the two or more wind turbines included in the group, a first vibration threshold and a second vibration threshold, receiving multiple second sets of time-series vibration data for a particular wind turbine of the multiple wind turbines, each second set of time-series vibration of the component of the particular wind turbine, identifying a particular group that includes the particular wind turbine, identifying, based on the particular group, a particular first vibration threshold and a particular second vibration threshold, determining, based on the multiple second sets of time-series vibration data, that a vibration of the component of the particular wind turbine has exceeded the particular first vibration threshold, generating a forecast of at least one of a period of time before the vibration of the component of the particular wind turbine may exceed the particular second vibration threshold and a future date at which the vibration of the component of the particular wind turbine may exceed the particular second vibration threshold, generating an alert, the alert including the particular wind turbine and at least one of the period of time and the future date, and providing the alert.

An example system may comprise at least one processor and memory containing executable instructions. The executable instructions may be executable by the at least one processor to: receive multiple first sets of time-series vibration data for multiple wind turbines, each first set of time-series vibration data for a component of a wind turbine of the multiple wind turbines, define, based on the multiple first sets of time-series vibration data, multiple groups of wind turbines of the multiple wind turbines, each group including two or more wind turbines of the multiple wind turbines, for each group of the multiple groups of wind turbines, define, based on a subset of the multiple first sets of time-series vibration data for the components of the two or more wind turbines included in the group, a first vibration threshold and a second vibration threshold, receive multiple second sets of time-series vibration data for a particular wind turbine of the multiple wind turbines, each second set of time-series vibration of the component of the particular wind turbine, identify a particular group that includes the particular wind turbine, identify, based on the particular group, a particular first vibration threshold and a particular second vibration threshold, determine, based on the multiple second sets of time-series vibration data, that a vibration of the component of the particular wind turbine has exceeded the particular first vibration threshold, generate a forecast of at least one of a period of time before the vibration of the component of the particular wind turbine may exceed the particular second vibration threshold and a future date at which the vibration of the component of the particular wind turbine may exceed the particular second vibration threshold, generate an alert, the alert including the particular wind turbine and at least one of the period of time and the future date, and provide the alert.

### BRIEF DESCRIPTION OF THE DRAWINGS

FIG. 1 depicts a block diagram of an example environment in which a renewable energy asset monitoring system systems may operate in some embodiments.

FIG. 2 is a block diagram of a renewable energy asset monitoring system in some embodiments.

FIG. 3 is a flow diagram depicting a method for generating a forecast for when a wind turbine component may exceed a threshold in some embodiments.

FIG. 4 is a graph showing vibration of a generator drive-end bearing component of a wind turbine at various stages according to some embodiments.

FIG. 5 depicts a fleet of multiple wind turbines and grouping of wind turbines of the fleet of multiple wind turbines according to some embodiments.

FIG. 6 is a graph showing grouping of wind turbines of multiple wind turbines according to some embodiments.

FIG. 7 is a graph showing a remaining safe operation period of a wind turbine based on vibration of a generator drive-end bearing component of a wind turbine.

FIG. 8 is a graph showing how the remaining safe operation period of a wind turbine decreases as vibration of the generator drive-end bearing component of the wind turbine increases.

FIG. 9A is a graph depicting vibration of a generator drive-end bearing component of a wind turbine under a single power class.

FIG. 9B is a graph depicting vibration of a generator drive-end bearing component of a wind turbine under multiple power classes.

FIG. 10A is a graph depicting vibration of a generator drive-end bearing component of a wind turbine under a single power class.

FIG. 10B is a graph depicting vibration of a generator drive-end bearing component of a wind turbine under multiple power classes.

FIG. 11A depicts a summary user interface for a renewable energy asset monitoring system in some embodiments.

FIG. 11B depicts a health overview card of a summary user interface for a renewable energy asset monitoring system in some embodiments.

FIG. 11C depicts an active alerts card of a summary user interface for a renewable energy asset monitoring system in some embodiments.

FIG. 12 depicts multiple cards of a turbine component details user interface for a renewable energy asset monitoring system in some embodiments.

FIG. 13 depicts a block diagram of an example digital device in some embodiments.

Throughout the drawings, like reference numerals will be understood to refer to like parts, components, and structures.

### DETAILED DESCRIPTION

Renewable energy assets are ubiquitous as legacy energy sources are both augmented and replaced. The health of renewable energy assets and/or renewable energy asset components has become increasingly important for energy production, safety, and asset longevity.

Sensor data that monitors behavior of one or more components of a renewable energy asset may be utilized to assess normal or abnormal operation. In one example, it may be beneficial to monitor wind turbines using wind turbine component time-series vibration data. In this example, time-series vibration data may be particularly useful for equipment that operates with rotating or reciprocating components, such as, for example, the drive-end bearing or non-drive-end bearing of a generator of a wind turbine.

In some embodiments, a renewable energy asset monitoring system as described herein may utilize vibration data as a condition indicator to baseline normal vibration behavior of the component for a group of wind turbines. It may be appreciated that any kind of data may be collected as a condition indicator. The renewable energy asset monitoring system may apply clustering techniques to discover groups of turbines which share similar operation levels (e.g., vibration levels). In some embodiments, once the condition breaches the first threshold of its assigned cluster, the renewable energy asset monitoring system may predict a time span (e.g., number of days) for the component indicator to reach the second threshold. This period, considered as a remaining safe operation period, may be a suggested window to service the component in to avoid any consequential damage and/or forced downtime.

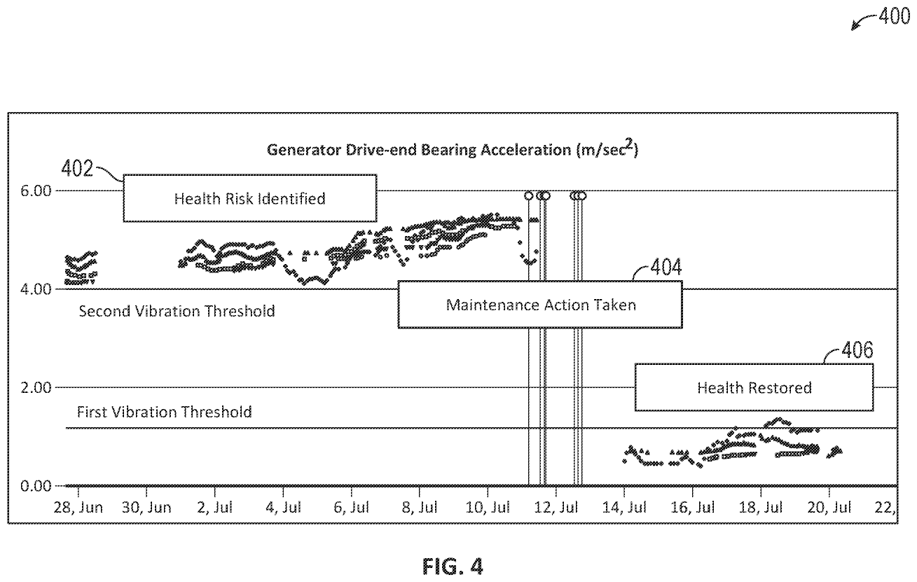

As discussed herein, it may be appreciated that any sensor data or combination of sensor data from any number of sensors may be utilized to determine normal and/or abnormal behavior. Vibration data is referred to with regard to FIG. 4, but any sensor data (e.g., including or not including vibration data) may be utilized and compared to different thresholds to indicate safe or unsafe (e.g., possibly damaging the equipment) operation.

FIG. 4 is a graph 400 showing vibration of a generator drive-end bearing component of a wind turbine at various stages according to some embodiments. The graph 400 depicts time-series vibration data for a generator drive-end bearing for multiple power classes. The renewable energy asset monitoring system may identify, based on the time-series vibration data exceeding the first vibration threshold and/or the second vibration threshold, that there is a health risk to the generator drive-end bearing, as indicated by label 402. Label 404 indicates that maintenance action on the generator drive-end bearing was taken (e.g., maintenance being performed because the second vibration threshold was exceeded and responsible part(ies) notified). The maintenance action restored the health of the generator drive-end bearing, as indicated by label 406.

Renewable energy asset monitoring system systems and associated methods described herein can quickly benchmark a fleet of wind turbines and assess the health condition of their components at scale. As traditional condition monitoring strategies are usually platform-specific or design-specific, it may take months for monitors to be in place for any newly introduced asset(s) or component(s). However, with renewable energy asset monitoring system systems and associated methods described herein, the time spent on identifying the monitor limits may be significantly reduced. Moreover, the renewable energy asset monitoring system systems and associated methods may also be applied to a wide range of wind turbines (and/or other types of renewable energy assets) and components of different designs and characteristics.

Furthermore, the renewable energy asset monitoring system and associated methods described herein are highly adaptive. When a component is replaced or the vibration sensor is re-calibrated, a shift in vibration measurement may be expected. Therefore, the monitor limit may be adjusted to avoid potential false alarms. In this case, the systems and methods described herein can quickly and easily adjust the baseline threshold by re-running the clustering against the vibration indicator from any period of interest. This greatly minimizes the manual effort required compared to other existing approaches.

Although the renewable energy asset monitoring system is described herein as monitoring wind turbines, the renewable energy asset monitoring system and associated methods are applicable to any component of any device may be monitored. Accordingly, as discussed herein, this disclosure is not limited to wind turbines or other renewable energy assets.

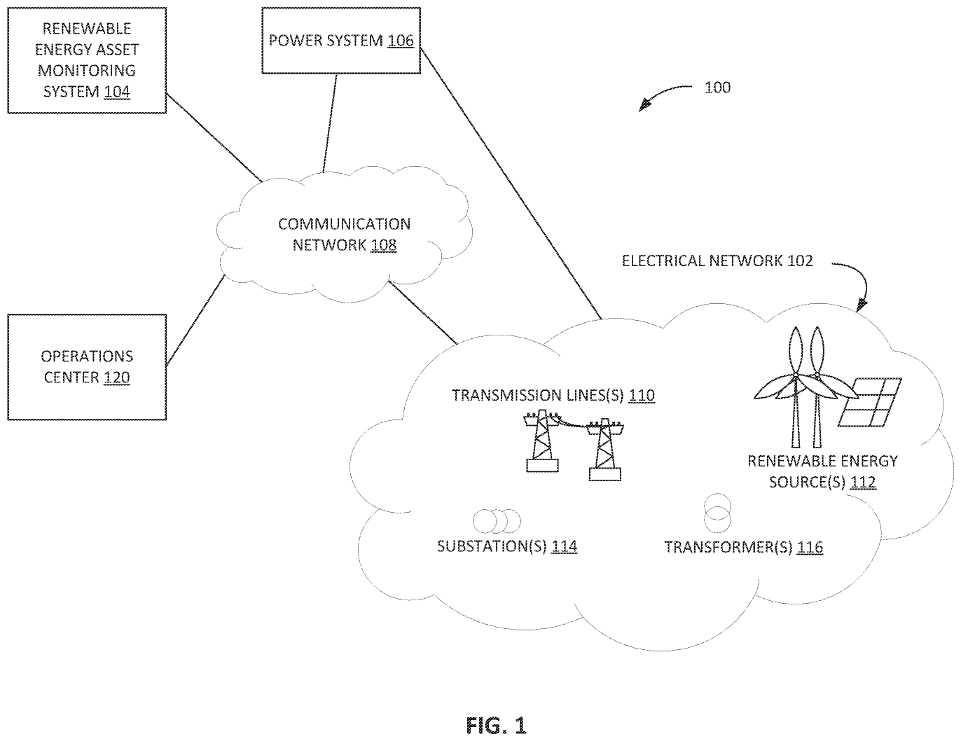

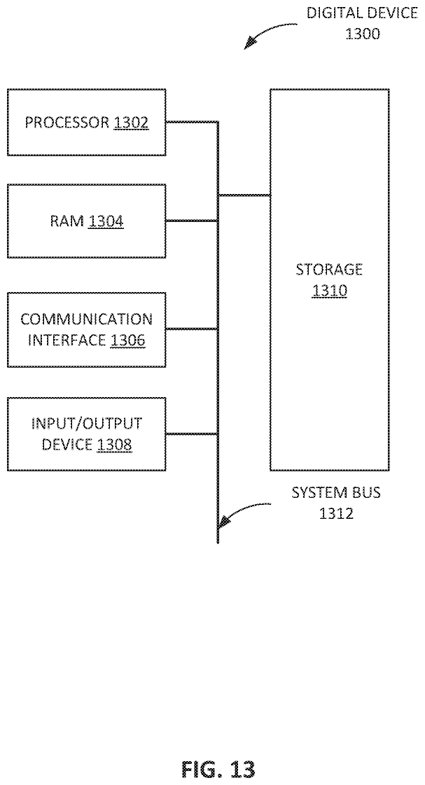

FIG. 1 depicts a block diagram of an example environment 100 in which the renewable energy asset monitoring system systems may operate in some embodiments. FIG. 1 includes an electrical network 102, a renewable energy asset monitoring system 104, a power system 106, and an operations center 120 in communication over a communication network 108. Each of the renewable energy asset monitoring system 104, the power system 106, and the operations center 120 may be or include any number of digital devices. A digital device is any device with at least one processor and memory. Digital devices are discussed further herein, for example, with reference to FIG. 13.

The electrical network 102 may include any number of transmission line(s) 110, renewable energy source(s) 112, substation(s) 114, and transformer(s) 116. The electrical network 102 may include any number of electrical assets including protective assets (e.g., relays or other circuits to protect one or more assets), transmission assets (e.g., lines, or devices for delivering or receiving power), and/or loads (e.g., residential houses, commercial businesses, and/or the like).

Components of the electrical network 102 such as the transmission line(s) 110, the renewable energy source(s) 112, substation(s) 114, and/or transformer(s) 116 may inject energy or power (or assist in the injection of energy or power) into the electrical network 102. Each component of the electrical network 102 may be represented by any number of nodes in a network representation of the electrical network. Renewable energy sources 112 may include solar panels, wind turbines, and/or other forms of so-called “green energy.” The electrical network 102 may include a wide electrical network grid (e.g., with 40,000 assets or more). Each electrical asset of the electrical network 102 may represent one or more elements of their respective assets. For example, the transformer(s) 116, as shown in FIG. 1 may represent any number of transformers in the electrical network 102.

In some embodiments, the renewable energy asset monitoring system 104 may be configured to receive sensor data from any number of sensors of any number of electrical assets, event data, and renewable energy asset production data. For example, the renewable energy asset monitoring system 104 may receive time-series vibration data from sensors associated with a rotating or reciprocating component of wind turbines, such as a generator shaft bearing. The renewable energy asset monitoring system 104 may subsequently group or cluster wind turbines that have similar vibration levels for the component. The renewable energy asset monitoring system 104 may then assign two statistical vibration thresholds to the group or cluster. A first vibration threshold may define a limit under which the component is considered to be operating normally. A second vibration threshold may define a limit in excess of which the component may be considered to be at a high risk of failure or forced downtime. The renewable energy asset monitoring system 104 may monitor the vibration of the component, and if the vibration exceeds the first vibration threshold, the renewable energy asset monitoring system 104 may generate a forecast for when the vibration may exceed the second vibration threshold. The renewable energy asset monitoring system 104 may then generate an alert for the wind turbine with the forecast and provide the alert. In some embodiments, the renewable energy asset monitoring system 104 may control the wind turbine, so as to prevent damage to the component and/or other components of the wind turbine. The renewable energy asset monitoring system 104 may include any number of digital devices configured to forecast component failure of any number of components and/or generators (e.g., wind turbine or solar power generator) of the renewable energy source(s) 112.

The renewable energy asset monitoring system 104 may send alerts to the operations center 120 for display by the operations center 120. The operations center 120 may control renewable energy assets 112 and/or other assets of the electrical network 102 based on alerts, reports, and/or other information received from the renewable energy asset monitoring system 104. The operations center 120 may include any number of digital devices configured to control the renewable energy sources 112.

The power system 106 may include any number of digital devices configured to control distribution and/or transmission of energy. The power system 106 may, in one example, be controlled by a power company, utility, and/or the like.

In some embodiments, the communication network 108 represents one or more computer networks (for example, LANs, WANs, and/or the like). The communication network 108 may provide communication between or among any of the renewable energy asset monitoring system 104 and any of the power system 106, the operations center 120, and the assets in the electrical network 102. In some implementations, the communication network 108 comprises computer devices, routers, cables, and/or other network topologies. In some embodiments, the communication network 108 may be wired and/or wireless. In various embodiments, the communication network 108 may comprise the Internet, one or more networks that may be public, private, IP-based, non-IP based, and so forth.

Examples of systems, environments, and/or configurations that may be suitable for use with the digital devices described herein include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like. A computer system may be described in the general context of computer system executable instructions, such as program modules, being executed by a computer system. Generally, program modules may include routines, programs, objects, components, logic, data structures, and so on that perform particular tasks or implement particular abstract data types.

While analysis and data associated with risk of failure is discussed herein, it may be appreciated that risk of failure may include risks associated with degeneration of performance, risk of outright failure, and/or risk of damage (e.g., either to a component or risk to a related component/subcomponent). For example, if a generator shaft is unbalanced then there may be pressure on the generator bearings which may cause them to fail or and/or be damaged. In various embodiments, some systems and methods discussed herein may be utilized to assist with risk assessment to help replace or repair components and/or subcomponents before damage or failure (or to improve performance).

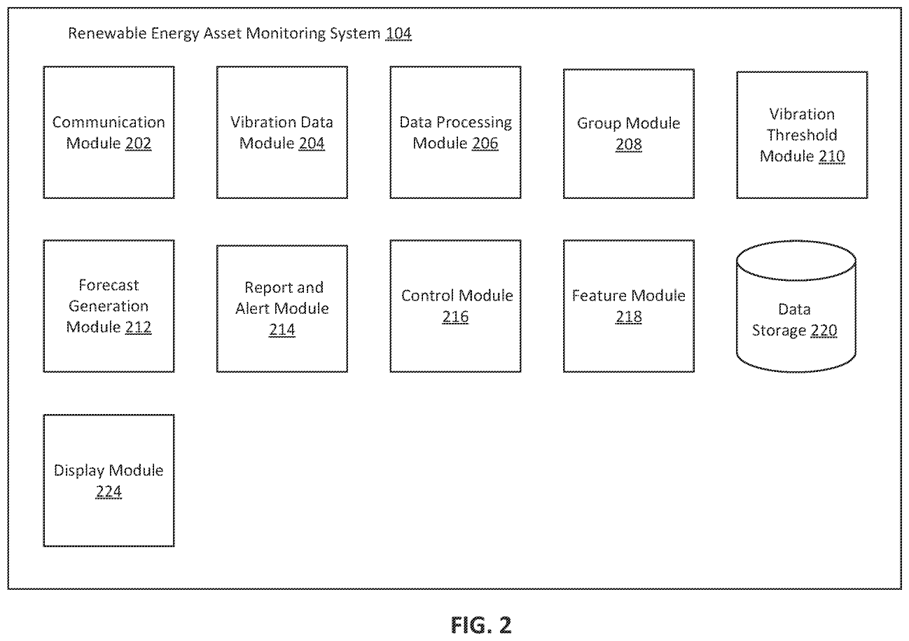

FIG. 2 is a block diagram of a renewable energy asset monitoring system 104 in some embodiments. The renewable energy asset monitoring system 104 may monitor any number of wind turbines on any number of wind turbine farms across any number of geographies (e.g., on-shore and/or off-shore geographies). The renewable energy asset monitoring system 104 may predict a component or subcomponent failure or risk of failure ahead of the actual failure. To predict the risk of failure, the renewable energy asset monitoring system 104 may train and evaluate any number of models that predict component failure. In some embodiments, the renewable energy asset monitoring system 104 trains a set of component or subcomponent failure prediction models for any number of components or subcomponents or set of components or subcomponents using historical sensor data received from sensors of any number of electrical assets (e.g., including renewable energy electrical assets such as wind turbines) on sensor information (e.g., such as SCADA and/or other signals or data further discussed herein). In some embodiments, each set of models predicts risk of failure of a set of components or subcomponents of the same or different electrical assets.

The renewable energy asset monitoring system 104 may train different failure prediction models of a set using the same metrics from historical sensor data but with different lead times and with different amounts of historical sensor data (e.g., different amounts of lookback times). The renewable energy asset monitoring system 104 may evaluate the failure prediction models of the set based on sensitivity, precision, and/or specificity for the different lookback and lead times. As a result, the renewable energy asset monitoring system 104 may select a failure prediction model of a set of failure prediction models for each component or subcomponent type (e.g., bearing), component or subcomponent (e.g., specific bearing(s) in one or more assets), component or subcomponent group type (e.g., generator including two or more components or subcomponents), component or subcomponent group (e.g., specific generator(s) including two or more components or subcomponents in one or more assets), asset type (e.g., wind turbines), or group of assets (e.g., specific set of wind turbines). Each failure prediction model may assist in predicting risk of failure (or poor health) of one or more components and/or subcomponents.

Metrics used to evaluate performance (e.g., based on values from sensor readings and/or from the sensors themselves) may be the same for different components even if the sensor data from sensors of the different components is different. In some embodiments, by standardizing metrics for evaluation, the renewable energy asset monitoring system 104 may “tune” or change aspects of the failure prediction model and model training to accomplish the goals of acceptable accuracy with acceptable lead time before the predicted failure. This enables improved accuracy for different components or subcomponents of an electrical assets with improved time of prediction (e.g., longer prediction times is preferable).

In some embodiments, the renewable energy asset monitoring system 104 may apply a multi-variate anomaly detection algorithm to sensors that are monitoring operating conditions of any number of renewable assets (e.g., wind turbines and/or solar generators). The renewable energy asset monitoring system 104 may remove data associated with a past, actual failure of the system (e.g., of any number of components and or devices), and/or increased risk of failure, therefore highlighting subtle anomalies from normal operational conditions that lead to actual failures or increased risk of failure(s).

In various embodiments, the renewable energy asset monitoring system 104 may fine-tune failure prediction models may remove noise from sensor data (e.g., apply principal component analysis to generate a failure prediction model using linearly uncorrelated data and/or features from the data). For example, the renewable energy asset monitoring system 104 may utilize factor analysis to identify the importance of features within sensor data in order to “de-noise” less important or relevant information from the signal. The renewable energy asset monitoring system 104 may also utilize one or more weighting vectors to highlight a portion or subset of sensor data that has high impact on the failure.

In some embodiments, the renewable energy asset monitoring system 104 may further scope time series data of the sensor data by removing some sensor data from the actual failure time period. In various embodiments, the renewable energy asset monitoring system 104 may optionally utilize curated data features to improve the accuracy of detection. Gearbox failure risk detection, for example, may utilize temperature rise in the gearbox with regards to power generation, reactive power, and ambient temperature.

In some embodiments, the renewable energy asset monitoring system 104 may receive historical sensor data of any number renewable energy sources (e.g., wind turbines, solar panels, wind farms, solar farms, electrical grants, and/or the like). The renewable energy asset monitoring system 104 may filter the sensor data to remove noise and/or break down the data in order to identify important features and remove noise of past failures or failure risk that may impact model building. The historical data may be optionally curated to further identify important features and remove noise. The renewable energy asset monitoring system 104 may further identify labels or categories for machine learning. It may be appreciated that renewable energy asset monitoring system 104 may, in some embodiments, identify labels.

The renewable energy asset monitoring system 104 may receive sensor data regarding any number of components or subcomponents from any number of devices, such as wind turbines from a wind farm. The sensor data may include multivariate timeseries data which, when in combination with the labels or categories for machine learning, may assist for deep learning, latent variable mining, to provide insights for component risk failure indication. These insights, which may predict upcoming failures or risk of failure(s), may effectively enable responses to upcoming failures with sufficient lead time before failure impacts other components of energy generation.

It may be appreciated that identifying risk of potential upcoming failures for any number of components or subcomponents and renewable energy generation may become increasingly important as sources of energy migrate to renewable energy. Failure of one or more components or subcomponents may impact the grid significantly, and as a result may put the electrical grid, or the legacy components of the electrical grid, either under burden or cause them to fail completely. Further, failures of the electrical grid and/or failures of renewable energy sources may threaten loss of property, business, or life particularly at times where energy is critical (e.g., hospital systems, severe weather conditions such as heat waves, blizzards, or hurricanes, care for the sick, care for the elderly, and/or care of the young).

The renewable energy asset monitoring system 104 may comprise a communication module 202, a vibration data module 204, a data processing module 206, a group module 208, a vibration threshold module 210, a forecast generation module 212, a report and alert module 214, a control module 216, a feature module 218, a display module 224, and a data storage 220. Examples discussed herein are with regard to wind turbines, but it may be appreciated that various systems and methods described herein may apply to any renewable energy asset (e.g., photovoltaic panels) or legacy electrical equipment. Additional functionality of modules and additional modules that the renewable energy asset monitoring system 104 may include may be described in U.S. patent application Ser. No. 16/235,361, entitled “SCALABLE SYSTEM AND METHOD FOR FORECASTING WIND TURBINE FAILURE WITH VARYING LEAD TIME WINDOWS”, filed Dec. 28, 2018, the entirety of which is incorporated by reference herein.

The communication module 202 may send requests and/or data between the renewable energy asset monitoring system 104 and any of the power system 106, the operations center 120, and the assets in the electrical network 102. The communication module 202 may also receive requests and/or data from any of the renewable energy asset monitoring system 104 and any of the power system 106, the operations center 120, and the assets in the electrical network 102.

The data processing module 206 may process data, such as sensor data (e.g., time-series vibration data), power data, and/or supervisory control and data acquisition (SCADA) data. In various embodiments, the data processing module 206 may perform filtering, feature generation, normalization, metadata generation, and/or the like.

The group module 208 may define, based on the time-series data from components of wind turbines and/or multiple groups of wind turbines. In one example, the group module 208 may define groups of wind turbines using clustering, such as k-means clustering.

The vibration threshold module 210 may define, for each group of wind turbines, based on time-series vibration data from the components of the wind turbines in the group, a first vibration threshold and a second vibration threshold. The first vibration threshold may define a limit under which the component of the wind turbine is considered to be operating normally. The second vibration threshold may define a limit in excess of which the component may be considered to be at a high risk of failure or forced downtime.

While the vibration threshold module 210 is identified in FIG. 2, it may be appreciated that there may be any number of threshold modules that may define, for each group of any type(s) of renewable energy assets, a first sensor threshold and a second sensor threshold (i.e., the threshold modules may define different thresholds for any number of different types of sensor data and are not limited to vibration). As discussed herein, the first sensor threshold may define a limit under which the component of the renewable energy asset or component(s) is considered to be operating normally. The second sensor threshold may define a limit in excess of which the renewable energy asset or component(s) may be considered to be at a high risk of failure or forced downtime.

Returning to the example using vibration, the forecast generation module 212 may, after the sensor indications of the component of a particular wind turbine has exceeded the first vibration threshold, generate a forecast of at least one of a period of time before the vibration of the component of the particular wind turbine is expected to exceed the particular second vibration threshold and a future date at which the vibration of the component of the particular wind turbine is expected to exceed the particular second vibration threshold. The forecast generation module 212 may generate the forecast using a trend in the time-series vibration data of the particular wind turbine, and optionally, other factors.

The report and alert module 214 may generate an alert after the vibration of the component of a particular wind turbine has exceeded the first vibration threshold. The alert may include the particular wind turbine and at least one of the period of time and the future date. The report and alert module 214 may provide the alert, for example, to the operations center 120 and/or the power system 106.

The control module 216 may control, based on the alert, the particular wind turbine, so as to prevent additional faults or consequential damage to the particular wind turbine. For example, the control module 216 may control the particular wind turbine to stop the turbine or operate the particular wind turbine at a lower power class than what the particular wind turbine typically operates.

The feature module 218 may generate, based on the time-series data, multidimensional features for wind turbines. The feature module 218 may generate the multidimensional features based on a mean, one or more standard deviations, and one or more percentiles of the multiple first sets of time-series data.

The display module 224 may generate user interfaces used to display health indicators and/or other information about wind turbines and components and subcomponents of wind turbines.

The data storage 220 may include data stored, accessed, and/or modified by any of the modules of the renewable energy asset monitoring system 104. The data storage 220 may include any number of data storage structures such as tables, databases, lists, and/or the like. The data storage 220 may include data that is stored in memory (for example, random access memory (RAM)), on disk, or some combination of in-memory and on-disk.

A module of the renewable energy asset monitoring system 104 may be hardware, software, firmware, or any combination. For example, each module may include functions performed by dedicated hardware (for example, an Application-Specific Integrated Circuit (ASIC), a Field Programmable Gate Array (FPGA), or the like), software, instructions maintained in ROM, and/or any combination. Software may be executed by one or more processors. Although a limited number of modules are depicted in FIG. 2, there may be any number of modules. Further, individual modules may perform any number of functions, including functions of multiple modules as described herein.

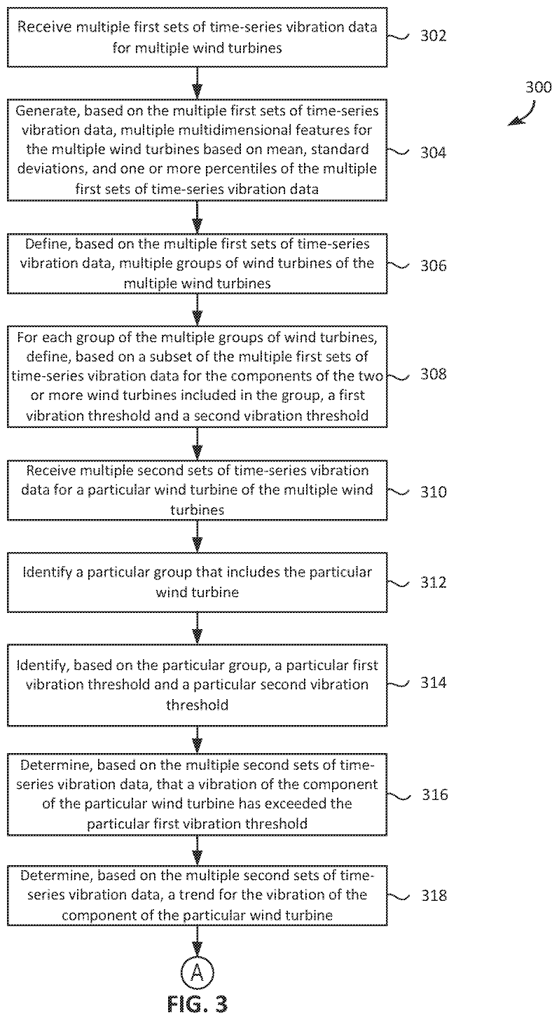

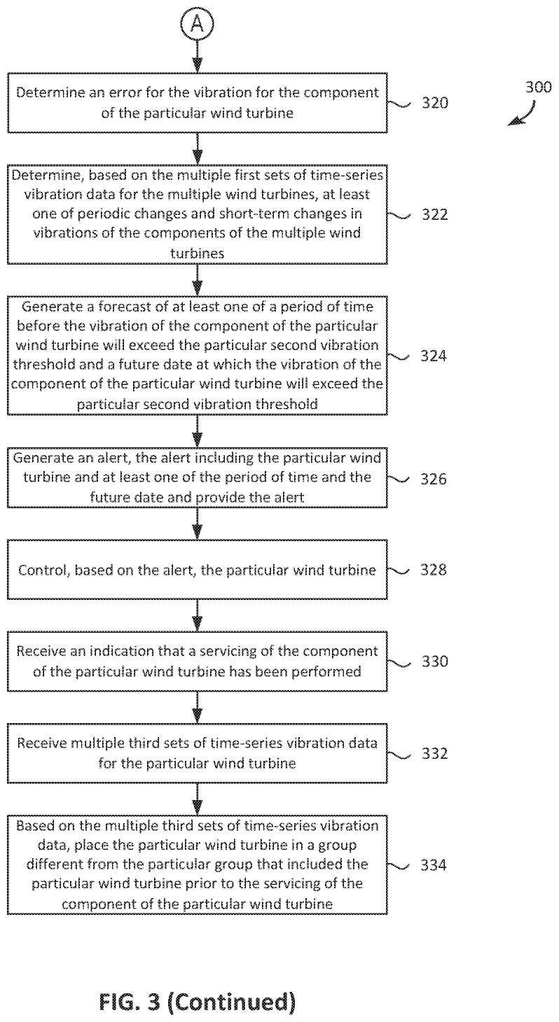

FIG. 3 is a flow diagram depicting a method 300 for generating a forecast for when a wind turbine component may exceed a threshold in some embodiments. The method 300 begins at step 302, where the renewable energy asset monitoring system 104 (for example, the vibration data module 204) receives multiple first sets of time-series vibration data for multiple wind turbines. Each first set of time-series vibration data is for a component of a wind turbine, such as the generator drive-end bearing. In some embodiments, the renewable energy asset monitoring system 104 may receive the failure history of the component of each wind turbine so that each first set of time-series vibration data is for a normal, or healthy, period of time of operation of the component. For example, each first set of time-series vibration data includes time-series vibration data for a period of time following a servicing of the component of the wind turbine of the multiple wind turbines.

At step 304, the renewable energy asset monitoring system 104 (for example, the feature module 218) generates, based on the multiple first sets of time-series vibration data, multiple multidimensional features for the multiple wind turbines based on mean, one or more standard deviations, and/or one or more percentiles of the multiple first sets of time-series vibration data. In some embodiments, the renewable energy asset monitoring system 104 generates, for each wind turbine, a mean of the vibration data, a standard deviation of the vibration data, and 30^{th}, 40^{th}, 50^{th}, 60^{th}, and 70^{th} percentiles of the vibration data.

At step 306 the renewable energy asset monitoring system 104 (for example, the group module 208) defines, based on the multiple first sets of time-series vibration data, multiple groups of wind turbines of the multiple wind turbines. Each group of wind turbines of the multiple wind turbines may include two or more wind turbines. In some embodiments, the renewable energy asset monitoring system 104 defines the multiple groups of wind turbines of the multiple wind turbines based on the mean, one or more standard deviations, and/or one or more percentiles of the multiple first sets of time-series vibration data. The renewable energy asset monitoring system 104 may store the associations between wind turbines and groups in the data storage 220.

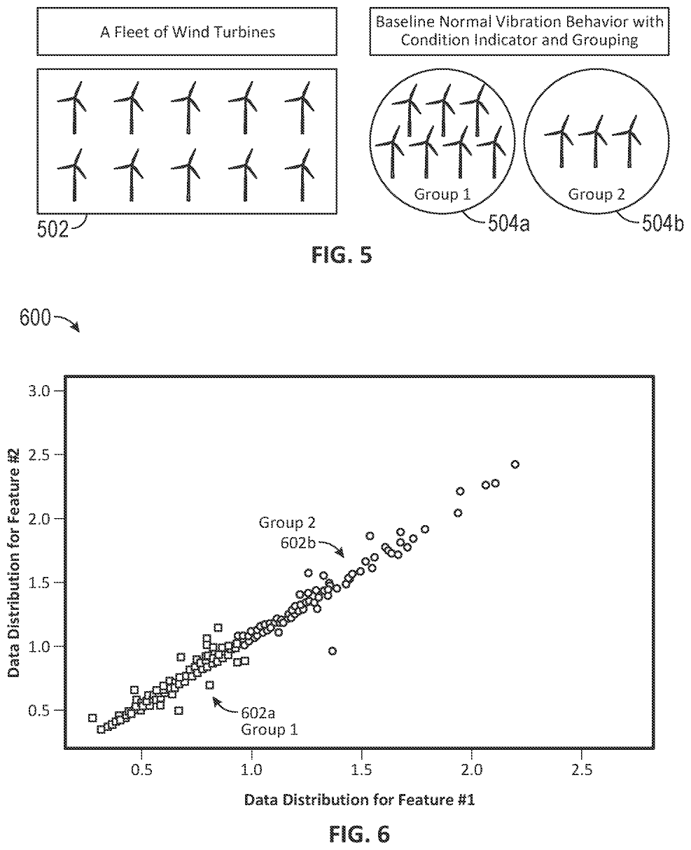

FIG. 5 depicts a fleet 502 of multiple wind turbines and a grouping of wind turbines of the multiple wind turbines according to some embodiments. In this example, the renewable energy asset monitoring system 104 groups the fleet 502 of the multiple wind turbines into two groups, a group 504a of wind turbines and a group 504b of wind turbines. Although group 504a depicts seven wind turbines and group 504b depicts three wind turbines, it is to be understood that these numbers are exemplary and that a group may include any number of wind turbines greater than or equal to two. Furthermore, although FIG. 5 depicts only two groups, there may be any number of groups.

In some embodiments, the renewable energy asset monitoring system 104 defines, based on the multiple first sets of time-series vibration data, multiple groups of wind turbines of the multiple wind turbines by clustering the multiple wind turbines, based on the multiple multidimensional features for the multiple wind turbines, to obtain clusters of wind turbines. Each cluster may include two or more wind turbines of multiple wind turbines. In such embodiments, the renewable energy asset monitoring system 104 creates multiple groups of wind turbines of the multiple wind turbines based on the multiple clusters of wind turbines.

The renewable energy asset monitoring system 104 may cluster renewable energy assets in any number of ways. In one example, the renewable energy asset monitoring system 104 performs k-means clustering under different initial numbers (k) of clusters to discover groups of wind turbines which share similar component vibration levels. In various embodiments, the renewable energy asset monitoring system 104 obtains clusters based on silhouette score(s), as silhouette score(s) may measure how dense and well-separated the clusters arc.

FIG. 6 depicts graph 600 showing a grouping of wind turbines of multiple wind turbines into two groups according to some embodiments. The graph 600 displays points for multiple wind turbines according to different features (e.g., a first feature and a second feature) of each of the multiple wind turbines. In some embodiments, the first feature is a mean of the vibration data, and the second feature is a 40th percentile of the vibration data.

The graph 600 depicts the wind turbines in a first group 602a with square points and the wind turbines in a second group 602b with circular points. It is to be understood that the renewable energy asset monitoring system 104 may perform clustering using additional or other features than a mean of the vibration data and a 40^{th} percentile of the vibration data. It is to be further understood that the renewable energy asset monitoring system 104 may define any number of groups of wind turbines greater than or equal to two.

Returning to FIG. 3, at step 308 the renewable energy asset monitoring system 104 (for example, the vibration threshold module 210), for each group of the multiple groups of wind turbines, defines, based on a subset of the multiple first sets of time-series vibration data for the components of the two or more wind turbines included in the group, a first vibration threshold and a second vibration threshold. The first vibration threshold may define a limit under which the component is considered to be operating normally. The second vibration threshold may define a limit in excess of which the component may be considered to be at a high risk of failure (which may be used to provide an alert of risk and/or a forced downtime).

In some embodiments, for each group of wind turbines, the renewable energy asset monitoring system 104 defines the first vibration threshold based on a mean and a standard deviation of the subset of the multiple first sets of time-series vibration data for the components of the two or more wind turbines included in the group. In various embodiments, the renewable energy asset monitoring system 104 defines the first vibration threshold based on the mean and three standard deviations of the subset of the multiple first sets of time-series vibration data for the components of the two or more wind turbines included in the group.

In some embodiments, each first set of time-series vibration data includes time-series vibration data for a period of time prior to a servicing of the component of the wind turbine or a failure of the component of the wind turbine. This period of time includes time when the component may be considered to be at a high risk of failure or forced downtime. In various embodiments, the renewable energy asset monitoring system 104 defines the second vibration threshold based on the mean of the subset of the multiple first sets of time-series vibration data for the period of time prior to the servicing of the component of the wind turbine of the multiple wind turbines or the failure of the component of the wind turbine for the components of the two or more wind turbines included in the group. It may be appreciated that the thresholds may be defined or determined in any number of ways (e.g., not limited to averaging).

At step 310 the renewable energy asset monitoring system 104 (for example, the vibration data module 204) receives multiple second sets of time-series vibration data for a particular wind turbine of the multiple wind turbines. Each second set of time-series vibration is of the component (for example, the generator drive-end bearing) of the particular wind turbine.

At step 312 the renewable energy asset monitoring system 104 (for example, the group module 208) identifies a particular group that includes the particular wind turbine. For example, the renewable energy asset monitoring system 104 may access the data storage 220 to determine the particular group with which the particular wind turbine is associated.

At step 314 the renewable energy asset monitoring system 104 (for example, the vibration threshold module 210) identifies, based on the particular group, a particular first threshold and a particular second threshold. At step 316 the renewable energy asset monitoring system 104 (for example, the vibration threshold module 210) determines, based on the multiple second sets of time-series vibration data, that a vibration of the component of the particular wind turbine has exceeded the particular first threshold.

At step 318 the renewable energy asset monitoring system 104 (for example, the forecast generation module 212) determines, based on multiple second sets of time-series vibration data, a trend for the vibration of the component of the particular wind turbine. For example, the renewable energy asset monitoring system 104 may determine a linear or non-linear trend for the vibration by fitting a linear or non-linear function to the multiple second sets of time-series vibration data.

At optional step 320, the renewable energy asset monitoring system 104 (for example, the forecast generation module 212) determines an error for the vibration of the component of the particular wind turbine. At step 322, the renewable energy asset monitoring system 104 (for example, the forecast generation module 212) determines, based on the multiple first sets of time-series vibration data for the multiple wind turbines, at least one of periodic changes and short-term changes in vibrations of the components of the multiple wind turbines.

At step 324 the renewable energy asset monitoring system 104 (for example, the forecast generation module 212) generates a forecast of at least one of a period of time before the vibration of the component of the particular wind turbine may exceed the particular second vibration threshold and a future date at which the vibration of the component of the particular wind turbine may exceed the particular second vibration threshold (e.g., based on probability). In some embodiments, the renewable energy asset monitoring system 104 generates a forecast using the following equation:

$$y ( t ) = g ( t ) + s ( t ) + e ( t )$$

where y(t) is the forecast, g(t) refers to trend (changes in vibration over, for example, a long period of time), s(t) refers to seasonality (periodic or short-term changes in vibration), and e(t) refers to the error term for vibration.

In some embodiments, the renewable energy asset monitoring system 104 generates the forecast based on the trend of the vibration for the particular wind turbine (or a type of a wind turbine such as the model and/or design) and the error for the vibration of the component of the particular wind turbine. In various embodiments, the renewable energy asset monitoring system 104 generates the forecast further based on at least one of the periodic changes and the short-term changes in vibrations of the components of the multiple wind turbines. In some embodiments, the renewable energy asset monitoring system 104 generates the forecast further based on the effects of holidays.

At step 326 the renewable energy asset monitoring system 104 (for example, the report and alert module 214) generates an alert. The alert includes the particular wind turbine and at least one of the period of time and the future date. The renewable energy asset monitoring system 104 also provides the alert, for example, to the operations center 120 and/or the power system 106.

In various embodiments, the renewable energy asset monitoring system 104 (for example, the control module 216) may, at step 328, control, based on the alert, the particular wind turbine, so as to prevent additional faults or consequential damage to the particular wind turbine. For example, the renewable energy asset monitoring system 104 may control the particular wind turbine to operate the particular wind turbine at a lower power class than what the particular wind turbine typically operates. Such operation may lower the risk of failure of the component or lengthen the period of time before which the particular wind turbine requires servicing of the component. Other examples of controlling the particular wind turbine are possible and may be apparent.

At step 330, the renewable energy asset monitoring system 104 (for example, the communication module 202) receives an indication that a servicing of the component of the particular wind turbine has been performed. At step 332, the renewable energy asset monitoring system 104 (for example, the vibration data module 204) receives multiple third sets of time-series vibration data for the particular wind turbine. Each third set of time-series vibration data is for the component of the particular wind turbine.

At step 334, the renewable energy asset monitoring system 104 (for example, the group module 208), based on the multiple third sets of time-series vibration data, places the particular wind turbine in a group different from the particular group that included the particular wind turbine prior to the servicing of the component of the particular wind turbine. For example, upon servicing of the particular wind turbine, the renewable energy asset monitoring system 104 may have removed the particular wind turbine from the group that the particular wind turbine was in. After servicing, the vibration of the component of the particular wind turbine is likely to have reduced. Accordingly, the renewable energy asset monitoring system 104 places the particular wind turbine in a group of other wind turbines with similar vibration characteristics for the component.

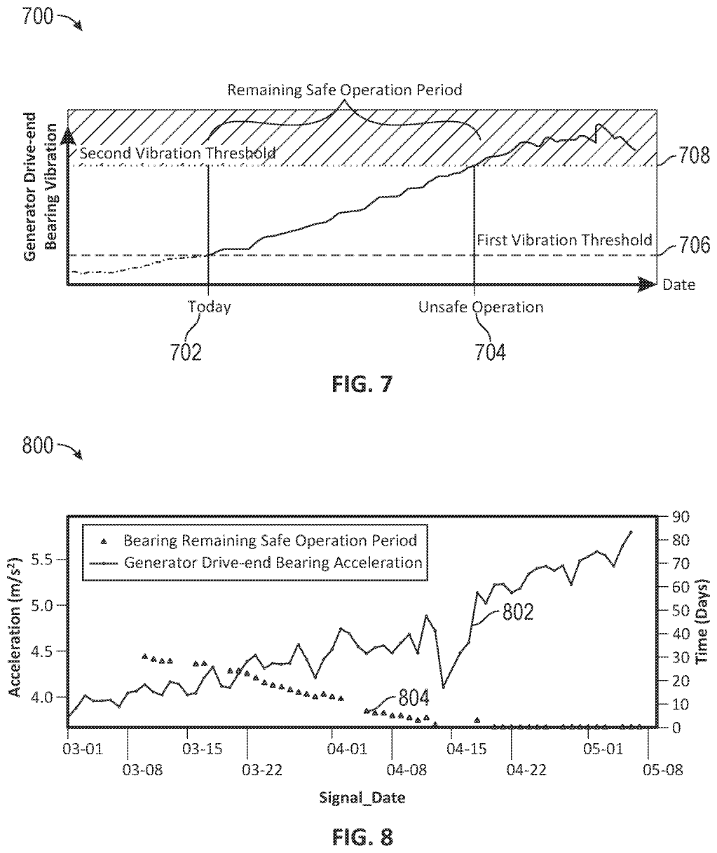

FIG. 7 depicts a graph 700 showing a remaining safe operation period of a wind turbine based on vibration of a generator drive-end bearing component of a wind turbine. The graph 700 depicts time-series vibration data for a generator drive-end bearing. In this example, the graph 700 indicates that the generator drive-end bearing vibration has exceeded the first vibration threshold 706 at a day 702, indicated as “Today.” The renewable energy asset monitoring system 104 has calculated a forecast for when the generator drive-end bearing vibration may exceed the second vibration threshold 708, which is forecasted to occur on a day 704, indicated as “Unsafe Operation.” The period of time between the day 702 and the day 704 may be considered as a remaining safe operation period. In context of this disclosure, the term unsafe is not intended to convey that operating the wind turbine poses a risk of personal injury or property damage. Rather, the term unsafe (and similar terms) is used to indicate a higher risk of failure of the indicated component and/or the wind turbine.

FIG. 8 depicts a graph 800 showing how the remaining safe operation period, indicated by triangles 804, of a wind turbine decreases as vibration of the generator drive-end bearing component of the wind turbine, indicated by line 802, increases.

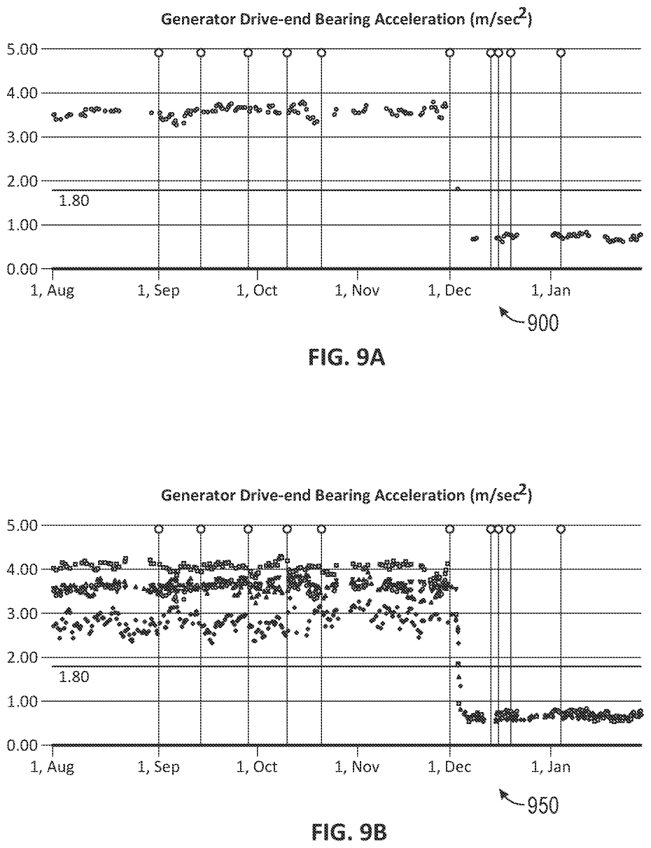

FIG. 9A depicts a graph 900 depicting vibration of a generator drive-end bearing component of a wind turbine under a single power class. The wind turbine had an alert on the generator drive-end bearing on June 11 when the first vibration threshold (1.80) of its condition indicator was breached. The generator drive-end bearing was serviced on November 30 and was restored to normal operation. FIG. 9B is a graph 950 depicting vibration of the generator drive-end bearing component of the wind turbine of FIG. 9A, but under multiple power classes.

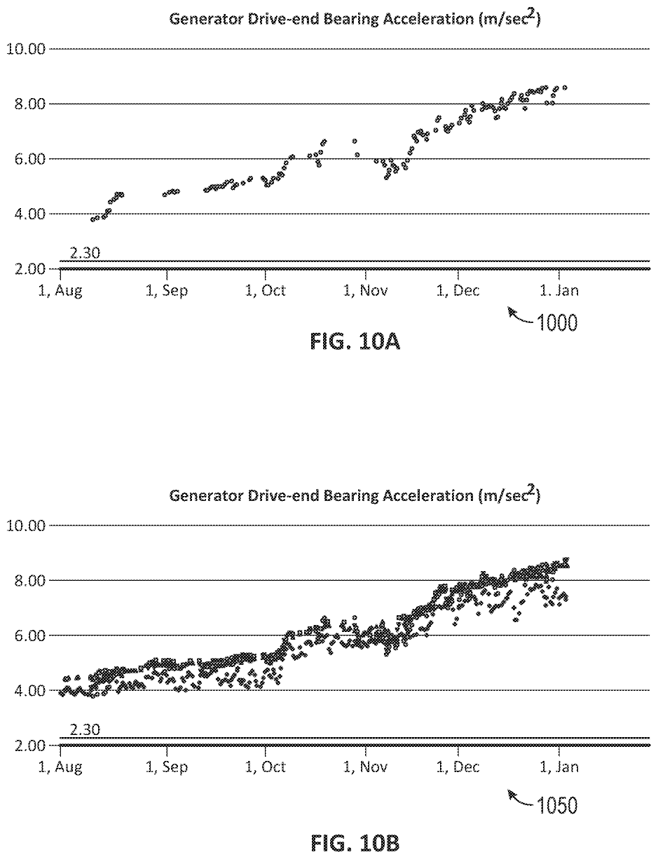

FIG. 10A depicts a graph 1000 depicting vibration of a generator drive-end bearing component of a wind turbine under a single power class. The wind turbine had an alert on the generator drive-end bearing since October 31, when the first vibration threshold (2.30) of its condition indicator was breached the health limit. As seen in the graph 1000, the vibration is still increasing. The remaining safe operation period is now zero according to the forecast. The forecast accordingly suggests that the generator drive-end bearing component should be serviced as soon as reasonably possible to avoid damage to the generator drive-end bearing component and/or to the wind turbine. FIG. 10B is a graph 1050 depicting vibration of the generator drive-end bearing component of the wind turbine of FIG. 10A, but under multiple power classes.

In addition to using vibration data, the renewable energy asset monitoring system 104 may utilize supervisory control and data acquisition (SCADA) data. For example, the renewable energy asset monitoring system 104 may utilize the following general SCADA data: Active Power, Alarm Number, Ambient Temperature, Available Power, Count of Runs, and Wind Direction; the following generator SCADA data: Generator Bearing Non-Drive End Temperature, Generator Bearing Drive End Temperature, Generator RPM, and Generator Cooling Temperature; and the following gearbox SCADA data: Gearbox Bearing Non-Drive End Temperature, Gearbox Bearing Drive End Temperature, Gearbox Cooling Temperature, Gearbox Inlet Temperature, Gearbox Main Tank Temperature, Gearbox Main Tank Oil Pressure, and Gearbox Pump RPM. The renewable energy asset monitoring system 104 may also utilize SCADA data other than that listed herein.

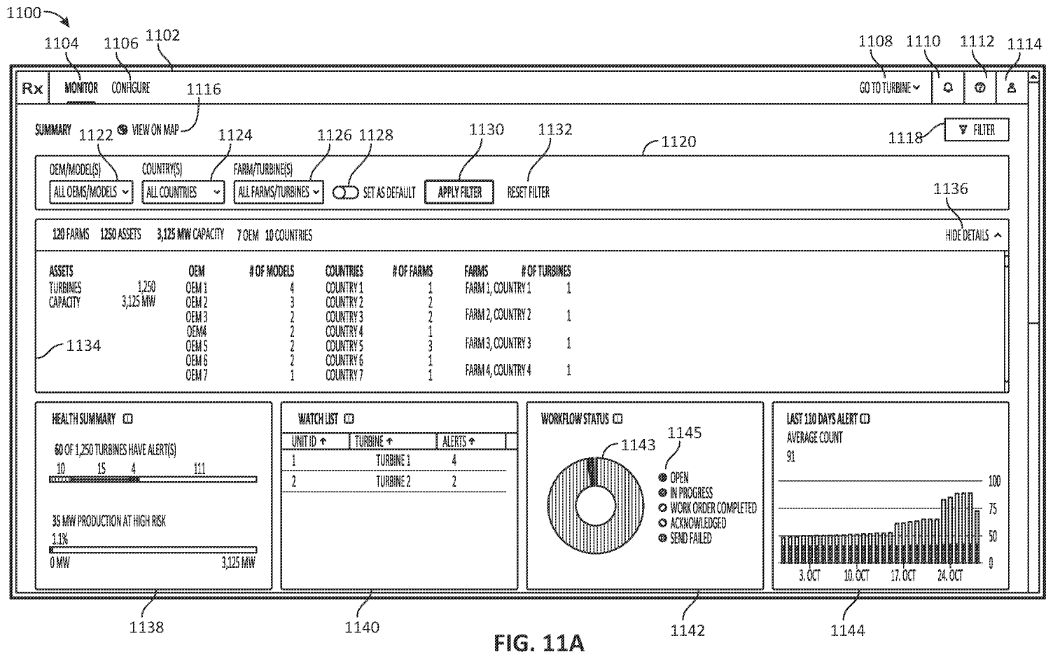

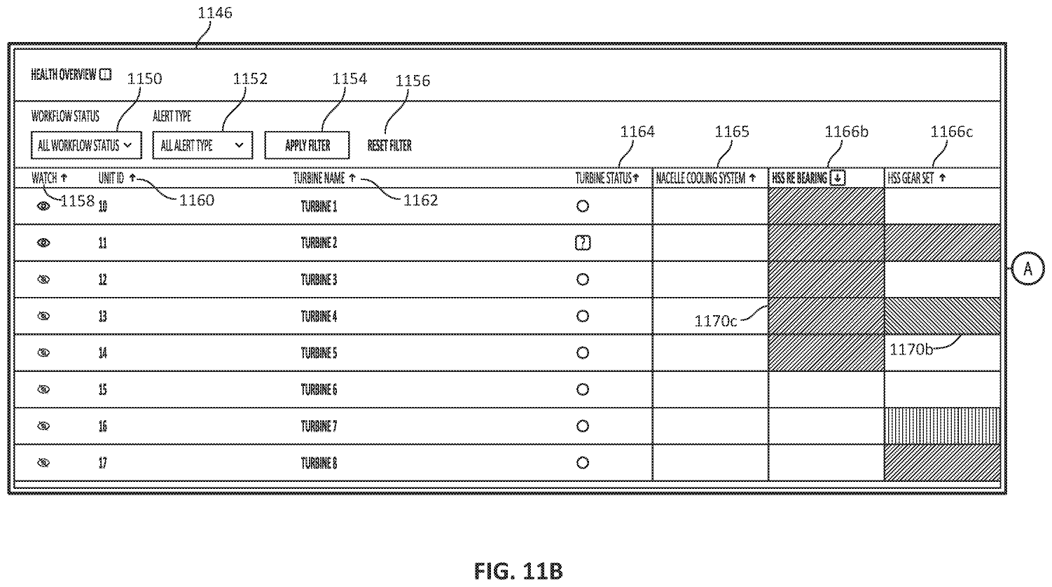

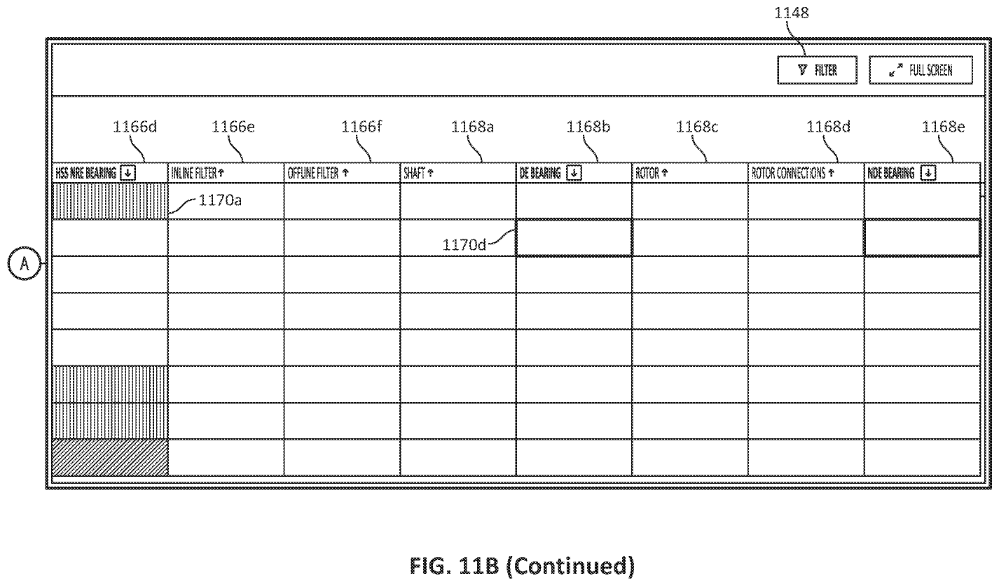

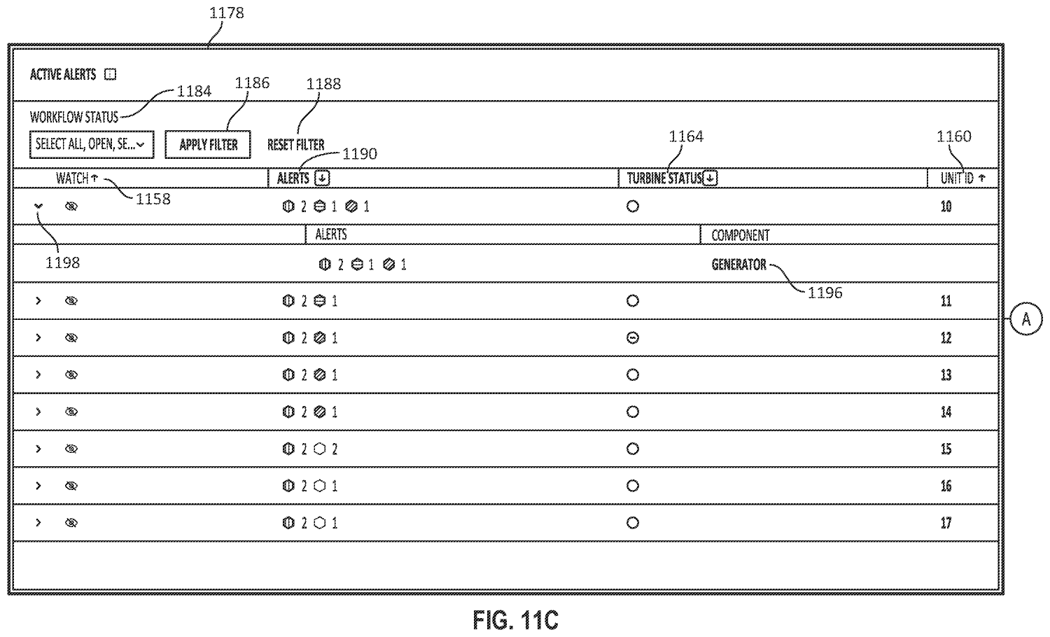

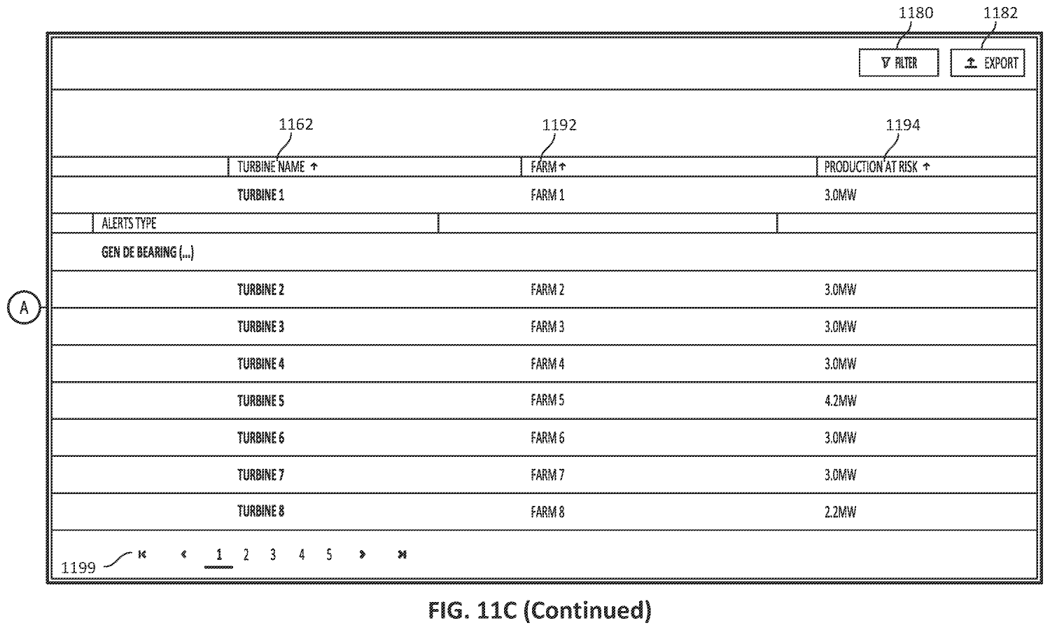

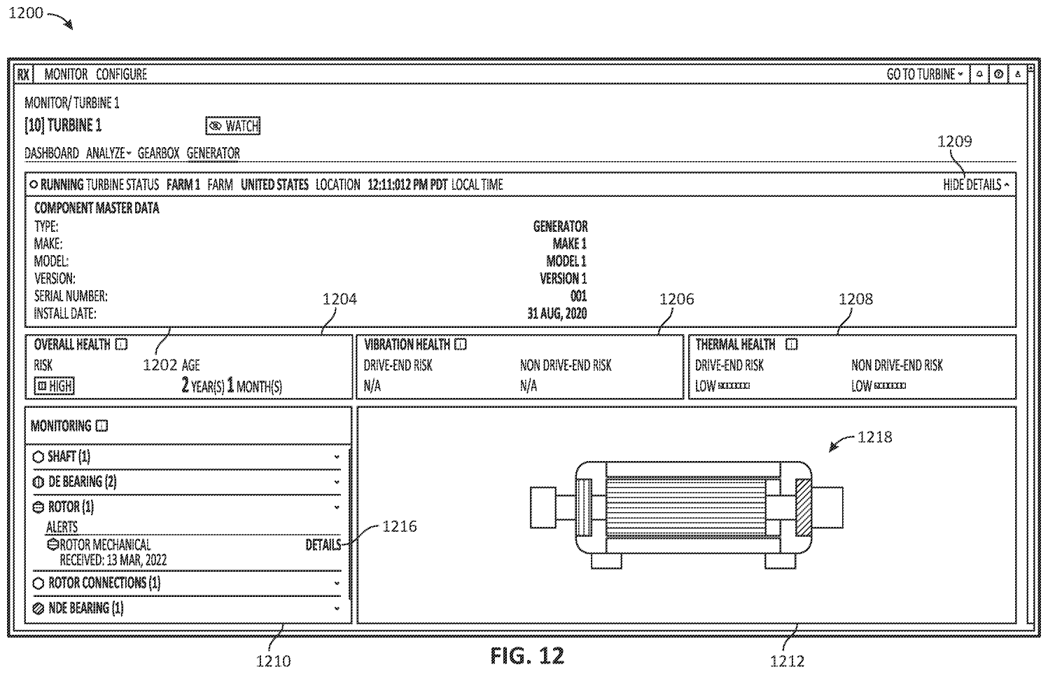

FIG. 11A depicts an example summary user interface 1100 for the renewable energy asset monitoring system 104 in some embodiments. Other example summary user interfaces for the renewable energy asset monitoring system 104 are described in pending U.S. patent application Ser. No. 18/540,452 filed Dec. 14, 2023, entitled “SYSTEMS AND METHODS FOR DISPLAYING RENEWABLE ENERGY ASSET HEALTH RISK INFORMATION”, the entirety of which is incorporated by reference herein. Modules discussed regarding FIG. 2 may also be discussed in the context of FIG. 11A. The display module 224 may be configured to generate the example summary user interface 1100 and the other example user interfaces discussed in the context of FIGS. 11A-12. The renewable energy asset monitoring system 104 may utilize the interfaces shown in FIGS. 11A-12 to provide alerts related to components of wind turbines exceeding the first vibration threshold and/or the second vibration threshold.

The display module 224 displays a header 1102 located at the top of the summary user interface 1100. The header 1102 includes a Monitor tab 1104, a Configure tab 1106, a Go to Turbine selector 1108, a notification icon 1110, a help icon 1112, and an account icon 1114. The Monitor tab 1104 may be the starting or default user interface of the renewable energy asset monitoring system 104. If a user of the renewable energy asset monitoring system 104 (hereinafter referred to as “the user”) selects the Configure tab 1106, the display module 224 displays a configure alert user interface, which is discussed with reference to FIGS. 10A-B. If the user selects the Go to Turbine selector 1108, the display module 224 displays a popup window (not shown in FIG. 11A) that has a list of farms and search input field. The user may select a farm from the list and then select a turbine in that farm. The user may also use the search input field to search for turbines. If the user selects the notification icon 1110, the display module 224 displays a popup window (not shown in FIG. 11A) that has a list of notifications. If the user selects the help icon 1112, the display module 224 displays a popup window (not shown in FIG. 11A) that has support contact information. If the user selects the account icon 1114, the display module 224 displays a popup window (not shown in FIG. 11A) that has a hyperlink to the account user interface, which is discussed with reference to FIG. 8.

When the Monitor tab 1104 is active, the summary user interface 1100 has a Summary heading and a globe icon and View on Map link 1116. If the user selects the globe icon and View on Map link 1116, the display module 224 may display a map user interface. The summary user interface 1100 also has a Filter button 1118. If the user selects the Filter button 1118, the display module 224 displays a Filter card 1120. The Filter card 1120 includes an OEM/Model(s) dropdown 1122 that allows the user to select one or more turbine OEMs and/or turbine models, a Country dropdown 1124 that allows the user to select one or more countries, and a Farm/Turbine(s) dropdown 1126 that allows the user to select one or more farms and/or turbines in the farms. The user may apply a filter to include the selected OEMs and/or Models, Countries, and Farms and/or Turbines using the Apply Filter button 1130. The user may reset the filter by selecting the Reset Filter link 1132. The user may set a filter as the default view using the Set As Default toggle 1128. If the user selects the Filter button 1118 again the display module 224 causes the Filter card 1120 to be hidden from view on the summary user interface 1100.

The summary user interface 1100 has additional cards including an Overview card 1134, a Health Summary card 1138, a Watch List card 1140, a Workflow Status card 1142, a Last 110 Days Alert card 1144, a Health Overview card 1146 (discussed with reference to FIG. 11B), and an Active Alerts card 1178 (discussed with reference to FIG. 11C). The Overview card 1134 lists the number of farms, the number of assets (turbines), total capacity in megawatts (MW), the number of original equipment manufacturers (OEMs) and the number of countries that the renewable energy asset monitoring system 104 monitors. The Overview card 1134 also has information regarding the number of assets (the number of turbines and the total capacity in MW), a list of the OEMs and the number of models of each OEM, a list of the countries and the number of farms in each country, and a list of the farms and the number of turbines in each farm. The user may collapse the Overview card 1134 by selecting a Hide Details link 1136. One advantage of the Overview card 1134 is that it provides high-level overview information on the turbines being monitored by the renewable energy asset monitoring system 104.

The Health Summary card 1138 shows a health summary of the user's selected population of turbines, including how many turbines have alerts and the impact to production based on the turbines with high severity risk alerts. The Health Summary card 1138 has a status bar indicating the number of turbines that have alerts (e.g., 60 of 1,250 turbines have alerts). In some embodiments, the alerts include a high severity risk alert that is shown in solid red (shown as vertical hashing in FIG. 11A), a medium severity risk alert that is shown in solid orange (shown as horizontal hashing in FIG. 11A), a low severity risk alert that is shown in solid yellow (shown as diagonal hashing in FIG. 11A), and an informational alert that is shown in solid gray (shown without hashing in FIG. 11A). The renewable energy asset monitoring system 104 may set the alert level for a turbine based on alert level(s) for one or more gearbox subcomponents and/or generator subcomponents of the turbine. How the renewable energy asset monitoring system 104 determines an alert level for a gearbox subcomponent and an alert level for a generator subcomponent is discussed with reference to the Health Overview card 1146.

It may be understood that the display module 224 may use different colors and/or shapes to display alert information. The Health Summary card 1138 also shows the amount of production (in MW) at high risk (e.g., 35 MW production at high risk) as well as the percentage of the overall total MW capacity (e.g., 1.1% at high risk of 3,125 MW capacity). One advantage of the Health Summary card 1138 is that it displays visual indications of alert severity for the turbines that have alerts, as well as the amount and percentage of production at risk, thus giving the user a sense of the overall health of the turbines that the renewable energy asset monitoring system 104 monitors.

The Watch List card 1140 shows a list of turbines that the user has selected to be watched. The watch list card displays a turbine unit ID, a turbine name, and a number of alerts for the turbine. As discussed with reference to the Health Overview card 1146, the user may add and remove a turbine from the Watch List card 1140. The turbine unit ID and the turbine name may be hyperlinked to a turbine details user interface. An advantage of the Watch List card 1140 is that it allows the user to keep track of turbines the user wants to look at frequently, e.g., every day, or that the user knows they would like to see more information about.

The Workflow Status card 1142 shows a graphical representation of high, medium and low severity active alerts, in the form of a doughnut chart 1143, that the user may act on, by workflow status 1145. The workflow statuses 1145 may include Open, Send Initiated, Send Failed, Work Order Completed, Acknowledged (an alert may be acknowledged without the alert being sent to a work order system), and In Progress. With regards to the Work Order Completed status, a work order may have a Work Order Completed status, but the condition prompting the work order has not normalized yet, and therefore the work order has not been closed out. The user may close an alert themselves before the condition has normalized, or the user may wait for the condition to normalize before closing out a work order. In some embodiments, the renewable energy asset monitoring system 104 may close the work order automatically once the condition normalizes. The doughnut chart 1143 displays workflow statuses portions with sizes corresponding to the number of their alerts in proportion to the total number of alerts. The user may hover over a portion of the doughnut chart 1143 to see the number of alerts for the corresponding workflow status 1145.

The user may toggle the inclusion of workflow statuses 1145 in the doughnut chart 1143 by selecting individual workflow statuses 1145. Toggling off an individual workflow status 1145 causes the display module 224 to display the individual workflow statuses 1145 that are toggled on in the doughnut chart 1143. For example, the user may toggle off individual workflow statuses 1145 except for the Open workflow status. The doughnut chart 1143 then displays alerts with a workflow status of Open. If the user selects a portion of the doughnut chart 1143 corresponding to a particular workflow status, the display module 224 updates the doughnut chart to provide a graphical representation of the active alerts for that workflow status by generator or gearbox component. The doughnut chart 1143 displays generator component and gearbox component portions with sizes corresponding to the number of their alerts in proportion to the total number of alerts for that workflow status. For example, the user may select the doughnut chart 1143 portion corresponding to the Open workflow status. The doughnut chart 1143 then displays a portion corresponding to the generator component and a portion corresponding to the gearbox component. The display module 224 sizes a portion in proportion to that component's part of the total number of alerts with an Open workflow status. It may be understood that different chart types may be used to graphically represent workflow statuses and components corresponding to active alerts. One advantage of the Workflow Status card 1142 is that it allows the user to quickly see the proportion the number alerts for each individual workflow status 1145 has to the total number of alerts.

The Last 110 Days Alert card 1144 depicts a vertical stacked bar chart with the daily number of alerts over the past 110 days with sub-bars for alert severities (high severity, medium severity, low severity, and information). The user may hover over a vertical bar, which represents a single day, to see the number of alerts by severity for that particular day. The Last 110 Days Alert card 1144 also displays the average number of alerts each day over the last 110 days. In some embodiments, periods of time other than days (e.g., weeks or months) are used to display the number of alerts for that time period. One advantage the Last 110 Days Alert card 1144 provides is that it allows the user to quickly determine what the overall trend for daily alerts is by alert severity as well as the average number of daily alerts for the last 110 days.

FIG. 11B depicts the Health Overview card 1146 of the summary user interface 1100 for the renewable energy asset monitoring system 104 in some embodiments. The Health Overview card 1146 has a list of turbines with the following columns: a watch 1158 with eye icons that allow the user to add or remove a turbine to or from the Watch List card 1140, a turbine unit ID 1160, a turbine name 1162, and a turbine status 1164. The turbine unit ID 1160 and turbine name 1162 may be hyperlinked to a turbine details user interface. The turbine status 1164 may include the following statuses: 1) running, which is visually indicated by an empty green circle (shown as an empty circle in FIG. 11B), 2) error, which is visually indicated by a solid red circle with a white horizontal dash (not shown in FIG. 11B), 3) unknown, which is visually indicated by a grey square with a question mark, and 4) communication failure, which is visually indicated by a grey square with an icon representing communication failure (not shown in FIG. 11B). The turbine list also has columns for displaying health indicators 1170 for nacelle subcomponents 1165, gearbox subcomponents 1166 and generator subcomponents 1168 that the renewable energy asset monitoring system 104 may monitor.

The Health Overview card 1146 has a Filter button 1148. If the user selects the Filter button 1148 the display module 224 displays a Workflow Status dropdown 1150, an Alert Type dropdown 1152, an Apply Filter button 1154, and a Reset Filter link 1156. The user may select one or more workflow statuses of work orders for filtering using the Workflow Status dropdown 1150. The workflow statuses may include Open, Send Initiated, Send Failed, Work Order Completed, Acknowledged, and In Progress. In some embodiments, the workflow statuses may include fewer or additional workflow statuses. The user may select one or more alert types for filtering using the Alert Type dropdown 1152. The gearbox component alerts may include Gbx HSS RE Bearing, Gbx HSS Gear, Gbx HSS NRE Bearing, Gbx Inline Oil Filter Pres, and Gbx Offline Oil Filter Pres. The generator component alerts may include Shaft Misalignment, Gen DE Bearing, Gen DE Bearing Temp, Generator DE Bearing CMS Data Missing, LF Signal Data Missing Generator Bearing DE, Rotor Mechanical, Rotor Connections, High Frequency Missing Data Generator NDE ROTOR, Gen NDE Bearing, Gen NDE Bearing Temp, Gen NDE Bearing CMS Data Missing, and LF Signal Data Missing GenDE. The gearbox and generator alerts may include fewer or additional alerts. The Alert Type dropdown 1152 may also include nacelle component alerts.

In another example, alerts may be generated associated with increased risk associated with degeneration of performance, risk of failure, and/or risk of damage, such as that associated with Generator Bearings (DE/NDE), Generator Overall Vibration Condition Monitor (DE/NDE), Generator Fan, Generator Slip Ring, Generator Rotor (Unbalance as example), Generator Shaft (Misalignment as an example), Gearbox HSS Bearings and Gears, Gearbox HSS Overall Vibration, Gearbox IMS Overall Vibration, Bearings, and Gears, Gearbox LSS Bearings and Gears, Gearbox Planetary-Bearings and Gears-all stages, Main Bearing as well, Tower (Cooling as example), and/or Nacelle (Cooling as example).

The user may select one or more workflow statuses using the Workflow Status dropdown 1150 and/or one or more alert types using the Alert Type dropdown 1152 and then apply a filter to include the selected one or more workflow statuses and/or the selected one or more alert types using the Apply Filter button 1154. The display module 224 then updates the list of turbines to include those turbines matching the selected one or more workflow statuses and/or the selected one or more alert types. For example, the user may wish to see turbines that have work orders with a workflow status of Open or Acknowledged and that have an alert for the generator DE Bearing subcomponent or the generator NDE Bearing subcomponent. The user may select the Open and Acknowledged workflow statuses in the Workflow Status dropdown 1150 and the Gen DE Bearing, Gen DE Bearing Temp, Generator DE Bearing CMS Data Missing, LF Signal Data Missing Generator Bearing DE alerts, Gen NDE Bearing, Gen NDE Bearing Temp, Gen NDE Bearing CMS Data Missing, and LF Signal Data Missing GenDE alerts in the Alert Type dropdown 1152. The user then may select the Apply Filter button 1154 to apply the filter. The display module 224 then displays those turbines that have work orders with a workflow status of Open or Acknowledged and that have an alert for the generator DE Bearing subcomponent or the generator NDE Bearing subcomponent. The user may then reset the filter by selecting the Reset Filter link 1156. The display module 224 removes the applied filter and displays the monitored turbines in the list of turbines. If the user selects the Filter button 1148 again the display module 224 hides the Workflow Status dropdown 1150, the Alert Type dropdown 1152, the Apply Filter button 1154, and the Reset Filter link 1156.

The report and alert module 214 may determine alert levels for gearbox subcomponents and generator subcomponents. As discussed herein, a statistical model may be applied to generate a forecast for potential failure of a gearbox subcomponent or a generator subcomponent. Additionally or alternatively, a machine learning and/or artificial intelligence model may be applied to generate the forecast for potential failure of a gearbox subcomponent or a generator subcomponent. The forecast may be compared to a threshold to determine at which point in a varying lead time the forecast may exceed the threshold if it does exceed the threshold.

For example, a varying lead time may be from about less than or equal to 15 days to about less than or equal to 90 days for the generator DE Bearing subcomponent. The report and alert module 214 may then determine the alert severity risk level (e.g., high severity risk, medium severity risk, low severity risk, or informational) for the generator DE Bearing subcomponent based on the determination at which point in the varying lead time window the forecast may exceed the threshold, if it does exceed the threshold. The report and alert module 214 may determine a high severity risk alert if the generator DE Bearing subcomponent may exceed the threshold in about less than or equal to 15 days. The report and alert module 214 may determine a medium severity risk alert if the generator DE Bearing subcomponent may exceed the threshold in about less than or equal to 110 days. The report and alert module 214 may determine a low severity risk alert if the generator DE Bearing subcomponent may exceed the threshold in about less than or equal to 90 days.

In some embodiments, the varying lead time may be longer for offshore turbines than for onshore turbines. In some embodiments, the user may change the varying lead time from the system. In some embodiments, the varying lead time may be set for component type (e.g., bearing), component (e.g., specific bearing(s) in one or more assets), component group type (e.g., generator including two or more components), component group (e.g., specific generator(s) including two or more components in one or more assets), asset type (e.g., wind turbines), group of assets (e.g., specific set of wind turbines), system user (e.g., a user in an organization), or group of system users (e.g., multiple users in an organization).

In the turbine list, the monitored nacelle subcomponents may include a Nacelle Cooling System subcomponent 1166a. The Nacelle Cooling System subcomponent 1166a displays health indicators 1170 for the nacelle cooling system alerts. In some embodiments, the monitored nacelle subcomponents may include additional nacelle subcomponents.

The monitored gearbox subcomponents 1166 may include the following subcomponents: 1) an HSS (High-Speed Stage) RE Bearing subcomponent (also referred to as a first gearbox bearing subcomponent) 1166b, an HSS Gear Set subcomponent (also referred to as a gear set subcomponent) 1166c, an HSS NRE Bearing subcomponent (also referred to as a second gearbox bearing subcomponent) 1166d, an Inline Filter subcomponent 1166c, and an Offline Filter subcomponent 1166f. The HSS RE Bearing subcomponent 1166b displays health indicators 1170 for alerts for the gearbox HSS RE Bearing subcomponent. The HSS Gear Set subcomponent 1166c displays health indicators 1170 for HSS Gear subcomponent alerts. The HSS NRE Bearing subcomponent 1166d displays health indicators 1170 for HSS NRE Bearing subcomponent alerts. The Inline Filter subcomponent 1166e displays health indicators 1170 for Gbx Inline Oil Filter Pres alerts. The Offline Filter subcomponent 1166f displays health indicators 1170 for Gbx Offline Oil Filter Pres alerts. In some embodiments, the monitored gearbox subcomponents 1166 may include fewer or additional gearbox subcomponents. We have Gbx IMS, shaft misalignment, and others in progress

The monitored generator subcomponents 1168 may include a Shaft subcomponent 1168a, a DE (Drive-End) Bearing subcomponent (also referred to as a first generator bearing subcomponent) 1168b, a Rotor subcomponent 1168c, a Rotor Connections subcomponent 1168d, and an NDE (Non-Drive-End) Bearing subcomponent (also referred to as a second generator bearing subcomponent) 1168e. The Shaft subcomponent 1168a displays health indicators 1170 for Shaft Misalignment alerts. The DE Bearing subcomponent 1168b displays health indicators 1170 for Gen DE Bearing, Gen DE Bearing Temp, Generator DE Bearing CMS Data Missing, and LF Signal Data Missing Generator Bearing DE alerts. The Rotor subcomponent 1168c displays health indicators 1170 for Rotor Mechanical alerts. The Rotor Connections subcomponent 1168d displays health indicators 1170 for Rotor Connections and High Frequency Missing Data Generator NDE ROTOR alerts. The NDE Bearing subcomponent 1168e displays health indicators 1170 for Gen NDE Bearing, Gen NDE Bearing Temp, Gen NDE Bearing CMS Data Missing, and LF Signal Data Missing GenDE alerts. The monitored generator subcomponents 1168 may include fewer or additional generator subcomponents in some embodiments.

The nacelle subcomponent column 1165, the gearbox subcomponents columns 1166 and the generator subcomponents columns 1168 display health indicators 1170 for the monitored nacelle subcomponents, gearbox subcomponents and generator subcomponents for which there are active alerts. The display module 224 may determine a health indicator for a monitored subcomponent based on the highest (or generally highest) severity active alert for the subcomponent. For example, a DE Bearing subcomponent 1168b may have a high severity active alert, a medium severity active alert, and an informational alert. The display module 224 would display a health indicator corresponding to a high severity active alert for the DE Bearing subcomponent 1168b. As another example, an HSS RE Bearing subcomponent 1166b may have a medium severity active alert and a low severity active alert. The display module 224 would display a health indicator corresponding to a medium severity active alert for the HSS RE Bearing subcomponent 1166b.

The display module 224 may display health indicators 1170 according to the following: 1) a high severity health indicator as a solid red rectangle 1170a (shown as a rectangle with vertical hashing in FIG. 11B) when the highest (or generally highest) severity level for active alerts for the monitored subcomponent is high, 2) a medium severity health indicator as an orange rectangle 1170b (shown as a rectangle with horizontal hashing in FIG. 11B) when the highest (or generally highest) severity level for active alerts for the monitored subcomponent is medium, 3) a low severity health indicator as a yellow rectangle 1170c (shown as a rectangle with diagonal hashing in FIG. 11B) when the highest (or generally highest) severity level for active alerts for the monitored subcomponent is low, and 4) an informational health indicator as a gray rectangle 1170d (shown as a rectangle with a thicker border in FIG. 11B) when the active alert is informational. The user may hover over a health indicator 1170 to see information about the active alert(s). The display module 224 then displays a popup containing information about the alert(s), such as the turbine name, hexagon icon(s) with the color or border corresponding to the alert severity level, and the date(s) of the alert(s). The display module 224 may hyperlink the health indicators 1170 to a turbine component details user interface.

Each of the columns 1158-1166 in the turbine list is sortable. The user may turn on sorting by selecting the arrow to the right of the column header. The user may sort a column ascending or descending, and the user may turn off sorting for the column. The user determines the column sort order by the order in which the user turns on sorting for columns. For example, the user may turn on sorting for the HSS RE Bearing subcomponent 1166b, then the HSS NRE bearing subcomponent 1166d, then the DE Bearing subcomponent 1168b, and then the NDE bearing subcomponent 1168e. The display module 224 sorts the turbine list by the HSS RE Bearing subcomponent 1166b first, the HSS NRE bearing subcomponent 1166d second, the DE Bearing subcomponent 1168b third, and the NDE bearing subcomponent 1168e fourth. The display module 224 sorts the nacelle subcomponent column 1166a, the gearbox subcomponents columns 1166 and the generator subcomponents columns 1168 in descending order from high severity health indicator to medium severity health indicator to low severity health indicator to informational health indicator to no active alerts. The display module 224 sorts the nacelle subcomponent column 1166a, the gearbox subcomponents columns 1166 and the generator subcomponents columns 1168 in the reverse (i.e., from informational to high) for ascending order.

One advantage of the Health Overview card 1146 is that it provides a view of the health indicators 1170 of multiple generator subcomponents and gearbox subcomponents of multiple turbines. The user may thus easily see the predicted health of such subcomponents without having to access multiple systems or visiting the assets personally. Another advantage is that the combination of turbine status data and the health indicators 1170 enables the user to make population-wide treatment decisions using a single view. Another advantage is that the sorting and filtering functionality of the Health Overview card 1146 allows the user to customize what data the user wishes to see, which allows the user to focus on specific problems.

FIG. 11C depicts an Active Alerts card 1178 of the summary user interface 1100 for the renewable energy asset monitoring system 104 in some embodiments. The display module 224 may display the Active Alerts card 1178, which shows a list of turbines with active alerts with the following columns: the watch 1158, an alerts 1190 that displays information about active alerts, the turbine status 1164, the turbine unit ID 1160, the turbine name 1162, a turbine farm 1192 that displays the name of the farm the turbine is in, and a production at risk 1194 that displays the production at risk in MW of the turbine. The display module 224 may hyperlink the turbine unit ID 1160 and the turbine name 1162 to a turbine details user interface. Each row of the turbine list has an arrow 1198. The user may use the arrow 1198 to expand the row. The display module 224 then shows more information about the active alerts, including the component 1196 (e.g., nacelle, generator, or gearbox) and the alerts type 1198. The component 1196 may be hyperlinked to a turbine component details user interface. The alerts type 1198 shows a single active alert and includes an ellipse in parentheses. The user may hover over the ellipse to see the other active alerts, if any. The Active Alerts card also has a page selector 1199 that allows the user to access different pages of turbines with alerts.

The Active Alerts card 1178 has a Filter button 1180. If the user selects the Filter button 1180, the display module 224 then displays a Workflow Status dropdown 1184, an Apply Filter button 1186, and a Reset Filter link 1188. The Workflow Status dropdown 1184 allows the user to select one or more workflow statuses of work orders for filtering. The workflow statuses may include Open, Send Initiated, Send Failed, Work Order Completed, Acknowledged, and In Progress. The workflow statuses may include fewer or additional workflow statuses. As a default all the workflow statuses may be selected, and the user may deselect workflow statuses. The user may select one or more workflow statuses using the Workflow Status dropdown and then select the Apply Filter button 1186. The display module 224 then updates the turbine list to include those turbines matching the selected one or more workflow statuses. If the user selects the Filter button 1180 again the display module 224 hides the Workflow Status dropdown 1184, the Apply Filter button 1186, and the Reset Filter link 1188. The Active Alerts card 1178 also has an Export button 1182. If the user selects the Export button 1182 the display module 224 exports the turbine list in a comma-separated values file that the user may download.

Like the columns in the turbine list in the Health Overview card 1146, each of the columns 1158-1162 and 1190-394 in the turbine list in the Active Alerts card 1178 is sortable. The user may turn on sorting by selecting the arrow to the right of the column header. The user may sort a column ascending or descending, and the user may turn off sorting for the column. The user determines the column sort order by the order in which the user turns on sorting for columns. For example, the user may sort by alerts 1190 in descending order first and turbine status 1164 in descending order second. The display module 224 then sorts the turbine list by the alerts in descending order first and turbine status 1164 in descending order second.

One advantage of the Active Alerts card 1178 is that it allows the user to see a list of turbines with alerts organized by the number and severity of alerts for that turbine. Another advantage is that the user may filter on workflow status so as to see turbines quickly and easily with alerts, and for each turbine, the number and severity of the alerts, the turbine status, the farm the turbine is located in, and the production at risk. Furthermore, the user may sort any of the columns in the turbine list.

FIG. 12 depicts a turbine component details user interface 1200 for a renewable energy asset monitoring system in some embodiments. The display module 224 may display the turbine component details user interface 1200 when, for example, the user selects a gearbox tab or a generator tab of a turbine details user interface (not shown in FIG. 12). The turbine component details user interface 1200 has multiple cards including an Overview card 1202, an Overall Health card 1204, a Vibration Health card 1206, a Thermal Health card 1208, a Monitoring card 1210, and a Subcomponent View card 1212. In FIG. 12, the content of the cards is for the generator component.

The Overview card 1202 lists the name of the farm, the geography, the status, and the local time of the turbine. The Overview card 1202 also has data about the component including the type, the make, the model, the version, the serial number, and the installation date. Some or all of this information may be obtained using a background reliability management process. The Overview card 1202 may be collapsed by the user selecting a Hide Details link 1209. One advantage of the Overview card 1202 is that it provides high-level information on the selected turbine component.

The Overall Health card 1204 shows the component risk and age. The component risk may be either high, moderate or low. The report and alert module 214 bases component risk on the combination of the monitored subcomponent health indicators, component vibration health, and component thermal health. The display module 224 may show a high risk as a red square (shown with vertical hashing in FIG. 12), a moderate risk as an orange square, and a low risk as a yellow square. The Vibration Health card 1206 shows the Drive-end Risk and the Non-Drive-end Risk, which are based on an overall vibration descriptor for the component. The display module 224 displays Vibration Drive-end Risk and Non Drive-end Risk as either Low (green bars), Moderate (orange bars), or High (red bars). The Thermal Health card 1208 shows the Thermal Drive-end and Non Drive-end Risk, which are based on temperature data modeling. The display module 224 displays Vibration Drive-end Risk and Non Drive-end Risk as either Low (green bars, shown as diagonal hashing in FIG. 12), Moderate (orange bars), or High (red bars). If the data is not available for vibration health or thermal health, the display module 224 displays an indication that the data is not available.

The Monitoring card 1210 has a list of monitored subcomponents for the generator component. The display module 224 displays each monitored subcomponent (e.g., Shaft, DE Bearing, Rotor, Rotor Connections, and NDE Bearing) and its corresponding alert level. A high severity risk is depicted using a solid red hexagon (shown with vertical hashing in FIG. 12) a medium severity risk is depicted using a solid orange hexagon (shown with horizontal hashing in FIG. 12), a low severity risk is depicted using a solid yellow hexagon (shown with diagonal hashing in FIG. 12), and a generally non-existent risk is shown as an empty green hexagon. The display module 224 displays an unmonitored component using an empty gray hexagon. The user may select a subcomponent to show the alerts for that particular subcomponent. For example, the Rotor subcomponent has a medium severity risk alert received Mar. 13, 2022. The user may select the Details hyperlink 1216, and the display module 224 may display the Subcomponent View card 1212.

The Subcomponent View card 1212 depicts a cross-sectional outline view 1218 of the outline of the generator including outlines of several generator subcomponents, such as the Shaft, the DE Bearing, the Rotor, the Rotor Connections, and the NDE bearing. The display module 224 shows the color of the border and/or fill of each subcomponent that corresponds to its alert severity in the cross-sectional outline view 1218. The alert severity of the DE bearing is high and thus the display module 224 displays the DE Bearing as solid red (shown as with vertical hashing in FIG. 12). The alert severity of the Rotor is medium and thus the display module 224 displays the Rotor as solid orange (shown as with horizontal hashing in FIG. 12). The alert severity of the NDE Bearing is low and thus the display module 224 displays the NDE Bearing as solid yellow (shown as with diagonal hashing in FIG. 12). The alert severity of the Shaft and the Rotor Connections is generally non-existent and thus the display module 224 displays the Shaft and the Rotor Connections using a green border and empty fill. The user may hover over a subcomponent and the display module 224 may display the component name and any alert information such as severity, type, and received date. In some embodiments, the display module 224 uses different colors to indicate alert severity of generator subcomponents. In some embodiments, the display module 224 uses different combinations of border and fill colors to indicate alert severities. One advantage of the Monitoring card 1210 and the Subcomponent View card 1212 is that they allow the user to see a list view of the alert severity of the generator subcomponents as well as a graphical depiction of the generator subcomponents with its subcomponents' alert levels visually indicated.

FIG. 13 depicts a block diagram of an example digital device 1300 according to some embodiments. The digital device 1300 is shown in the form of a general-purpose computing device. The digital device 1300 includes at least one processor 1302, RAM 1304, communication interface 1306, input/output device 1308, storage 1310, and a system bus 1312 that couples various system components including storage 1310 to the at least one processor 1302. A system, such as a computing system, may be or include one or more of the digital device 1300.

System bus 1312 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

The digital device 1300 typically includes a variety of computer system readable media, such as computer system readable storage media. Such media may be any available media that is accessible by any of the systems described herein and it includes both volatile and nonvolatile media, removable and non-removable media.

In some embodiments, the at least one processor 1302 is configured to execute executable instructions (for example, programs). In some embodiments, the at least one processor 1302 comprises circuitry or any processor capable of processing the executable instructions.

In some embodiments, RAM 1304 stores programs and/or data. In various embodiments, working data is stored within RAM 1304. The data within RAM 1304 may be cleared or ultimately transferred to storage 1310, such as prior to reset and/or powering down the digital device 1300.

In some embodiments, the digital device 1300 is coupled to a network, such as the communication network 108, via communication interface 1306. Any of the renewable energy asset monitoring system 104, the power system 106, the operations center 120, and the assets in the 102/can communicate with one or more networks such as a local area network (LAN), a general wide area network (WAN), and/or a public network (for example, the Internet).

In some embodiments, input/output device 1308 is any device that inputs data (for example, mouse, keyboard, stylus, sensors, etc.) or outputs data (for example, speaker, display, virtual reality headset).

In some embodiments, storage 1310 can include computer system readable media in the form of non-volatile memory, such as read only memory (ROM), programmable read only memory (PROM), solid-state drives (SSD), flash memory, and/or cache memory. Storage 1310 may further include other removable/non-removable, volatile/non-volatile computer system storage media. By way of example only, storage 1310 can be provided for reading from and writing to a non-removable, non-volatile magnetic media. The storage 1310 may include a non-transitory computer-readable medium, or multiple non-transitory computer-readable media, which stores programs or applications for performing functions such as those described herein with reference to, for example, FIG. 2. Although not shown, a magnetic disk drive for reading from and writing to a removable, non-volatile magnetic disk (for example, a “floppy disk”), and an optical disk drive for reading from or writing to a removable, non-volatile optical disk such as a CDROM, DVD-ROM or other optical media can be provided. In such instances, each can be connected to system bus 1312 by one or more data media interfaces. As will be further depicted and described below, storage 1310 may include at least one program product having a set (for example, at least one) of program modules that are configured to carry out the functions of embodiments of the invention. In some embodiments, RAM 1304 is found within storage 1310.

Programs/utilities, having a set (at least one) of program modules, such as those of the renewable energy asset monitoring system 104, may be stored in storage 1310 by way of example, and not limitation, as well as an operating system, one or more application programs, other program modules, and program data. Each of the operating system, one or more application programs, other program modules, and program data or some combination thereof, may include an implementation of a networking environment. Program modules generally carry out the functions and/or methodologies of embodiments of the invention as described herein.

It should be understood that although not shown, other hardware and/or software components could be used in conjunction with the digital device 1300. Examples include, but are not limited to microcode, device drivers, redundant processing units, and external disk drive arrays, RAID systems, tape drives, and data archival storage systems, etc.

Exemplary embodiments are described herein in detail with reference to the accompanying drawings. However, the present disclosure can be implemented in various manners, and thus should not be construed to be limited to the embodiments disclosed herein. On the contrary, those embodiments are provided for the thorough and complete understanding of the present disclosure, and completely conveying the scope of the present disclosure.

It may be appreciated that aspects of one or more embodiments may be embodied as a system, method, or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), a solid state drive (SSD), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program or data for use by or in connection with an instruction execution system, apparatus, or device.

A transitory computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object-oriented programming language such as Java, Smalltalk, C++, Python, or the like and conventional procedural programming languages, such as the “C” programming language or similar programming languages. The computer program code may execute entirely on any of the systems described herein or on any combination of the systems described herein.

Aspects of the present invention are described below with reference to flowchart illustrations and/or block diagrams of methods, apparatus (systems) and computer program products according to embodiments of the invention. It may be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

While specific examples are described above for illustrative purposes, various equivalent modifications are possible. For example, while processes or blocks are presented in a given order, alternative implementations may perform routines having steps, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented concurrently or in parallel or may be performed at different times. Further any specific numbers noted herein are only examples: alternative implementations may employ differing values or ranges.

Throughout this specification, plural instances may implement components, operations, or structures described as a single instance. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. Furthermore, any specific numbers noted herein are only examples: alternative implementations may employ differing values or ranges.

Components may be described or illustrated as contained within or connected with other components. Such descriptions or illustrations are examples only, and other configurations may achieve the same or similar functionality. Components may be described or illustrated as “coupled,” “couplable,” “operably coupled,” “communicably coupled” and the like to other components. Such description or illustration should be understood as indicating that such components may cooperate or interact with each other, and may be in direct or indirect physical, electrical, or communicative contact with each other.

Components may be described or illustrated as “configured to,” “adapted to,” “operative to,” “configurable to,” “adaptable to,” “operable to” and the like. Such description or illustration should be understood to encompass components both in an active state and in an inactive or standby state unless required otherwise by context.

The use of “or” in this disclosure is not intended to be understood as an exclusive “or.” Rather, “or” is to be understood as including “and/or.” For example, the phrase “providing alerts or reports” is intended to be understood as having several meanings: “providing alerts,” “providing reports,” and “providing alerts and reports.”

It may be apparent that various modifications may be made, and other embodiments may be used without departing from the broader scope of the discussion herein. Therefore, these and other variations upon the example embodiments are intended to be covered by the disclosure herein.

1. A non-transitory computer-readable medium comprising executable instructions, the executable instructions being executable by one or more processors to perform a method, the method comprising:
receiving multiple first sets of time-series vibration data for multiple wind turbines, each first set of time-series vibration data for a component of a wind turbine of the multiple wind turbines;
defining, based on the multiple first sets of time-series vibration data, multiple groups of wind turbines of the multiple wind turbines, each group including two or more wind turbines of the multiple wind turbines;
for each group of the multiple groups of wind turbines, defining, based on a subset of the multiple first sets of time-series vibration data for the components of the two or more wind turbines included in the group, a first vibration threshold and a second vibration threshold;
receiving multiple second sets of time-series vibration data for a particular wind turbine of the multiple wind turbines, each second set of time-series vibration of the component of the particular wind turbine;
identifying a particular group that includes the particular wind turbine;
identifying, based on the particular group, a particular first vibration threshold and a particular second vibration threshold;
determining, based on the multiple second sets of time-series vibration data, that a vibration of the component of the particular wind turbine has exceeded the particular first vibration threshold;
generating a forecast of at least one of a period of time before the vibration of the component of the particular wind turbine may exceed the particular second vibration threshold and a future date at which the vibration of the component of the particular wind turbine may exceed the particular second vibration threshold;
generating an alert, the alert including the particular wind turbine and at least one of the period of time and the future date; and
providing the alert.

2. The non-transitory computer-readable medium of claim 1, the method further comprising controlling, based on the alert, the particular wind turbine.

3. The non-transitory computer-readable medium of claim 1 wherein each first set of time-series vibration data includes time-series vibration data for a period of time following a servicing of the component of the wind turbine of the multiple wind turbines.

4. The non-transitory computer-readable medium of claim 3 wherein for each group of the multiple groups of wind turbines, defining, based on the subset of the multiple first sets of time-series vibration data for the components of the two or more wind turbines included in the group, the first vibration threshold and the second vibration threshold includes, for each group of the multiple groups of wind turbines, defining, based on a mean and a standard deviation of the subset of the multiple first sets of time-series vibration data for the components of the two or more wind turbines included in the group, the first vibration threshold.

5. The non-transitory computer-readable medium of claim 1 wherein each first set of time-series vibration data includes time-series vibration data for a period of time prior to a servicing of the component of the wind turbine of the multiple wind turbines or a failure of the component of the wind turbine of the multiple wind turbines.

6. The non-transitory computer-readable medium of claim 5 wherein for each group of the multiple groups of wind turbines, defining, based on the subset of the multiple first sets of time-series vibration data for the components of the two or more wind turbines included in the group, the first vibration threshold and the second vibration threshold includes, for each group of the multiple groups of wind turbines, defining, based on a mean of the subset of the multiple first sets of time-series vibration data for the period of time prior to the servicing of the component of the wind turbine of the multiple wind turbines or the failure of the component of the wind turbine of the multiple wind turbines for the components of the two or more wind turbines included in the group, the second vibration threshold.

7. The non-transitory computer-readable medium of claim 1, further comprising:
determining, based on the multiple second sets of time-series vibration data, a trend for the vibration of the component of the particular wind turbine; and
determining an error for the vibration of the component of the particular wind turbine,
wherein generating the forecast of at least one of the period of time before the vibration of the component of the particular wind turbine may exceed the particular second vibration threshold and the future date at which the vibration of the component of the particular wind turbine may exceed the particular second vibration threshold includes generating, based on the trend of the vibration for the particular wind turbine and the error for the vibration of the component of the particular wind turbine, the forecast of at least one of the period of time before the vibration of the component of the particular wind turbine may exceed the particular second vibration threshold and the future date at which the vibration of the component of the particular wind turbine may exceed the particular second vibration threshold.

8. The non-transitory computer-readable medium of claim 7, further comprising determining, based on the multiple first sets of time-series vibration data for the multiple wind turbines, at least one of periodic changes and short-term changes in vibrations of the components of the multiple wind turbines,
wherein generating the forecast of at least one of the period of time before the vibration of the component of the particular wind turbine may exceed the particular second vibration threshold and the future date at which the vibration of the component of the particular wind turbine may exceed the particular second vibration threshold further includes generating, based on at least one of the periodic changes and the short-term changes in vibrations of the components of the multiple wind turbines, the forecast of at least one of the period of time before the vibration of the component of the particular wind turbine may exceed the particular second vibration threshold and the future date at which the vibration of the component of the particular wind turbine may exceed the particular second vibration threshold.

9. The non-transitory computer-readable medium of claim 1 wherein defining, based on the multiple first sets of time-series vibration data, the multiple groups of wind turbines of the multiple wind turbines, includes defining, based on mean, one or more standard deviations, and one or more percentiles of the multiple first sets of time-series vibration data, the multiple groups of wind turbines of the multiple wind turbines.

10. The non-transitory computer-readable medium of claim 1, the method further comprising generating, based on the multiple first sets of time-series vibration data, multiple multidimensional features for the multiple wind turbines based on mean, one or more standard deviations, and one or more percentiles of the multiple first sets of time-series vibration data,
wherein defining, based on the multiple first sets of time-series vibration data, the multiple groups of wind turbines of the multiple wind turbines, includes:
clustering the multiple wind turbines, based on the multiple multidimensional features for the multiple wind turbines, to obtain multiple clusters of wind turbines, each cluster including two or more wind turbines of the multiple wind turbines; and
creating the multiple groups of wind turbines of the multiple wind turbines based on the multiple clusters of wind turbines.

11. The non-transitory computer-readable medium of claim 1, the method further comprising:
receiving an indication that a servicing of the component of the particular wind turbine has been performed;
receiving multiple third sets of time-series vibration data for the particular wind turbine, each third set of time-series vibration data for the component of the particular wind turbine; and
based on the multiple third sets of time-series vibration data, placing the particular wind turbine in a group different from the particular group that included the particular wind turbine prior to the servicing of the component of the particular wind turbine.

12. A method comprising:
receiving multiple first sets of time-series vibration data for multiple wind turbines, each first set of time-series vibration data for a component of a wind turbine of the multiple wind turbines;
defining, based on the multiple first sets of time-series vibration data, multiple groups of wind turbines of the multiple wind turbines, each group including two or more wind turbines of the multiple wind turbines;
for each group of the multiple groups of wind turbines, defining, based on a subset of the multiple first sets of time-series vibration data for the components of the two or more wind turbines included in the group, a first vibration threshold and a second vibration threshold;
receiving multiple second sets of time-series vibration data for a particular wind turbine of the multiple wind turbines, each second set of time-series vibration of the component of the particular wind turbine;
identifying a particular group that includes the particular wind turbine;
identifying, based on the particular group, a particular first vibration threshold and a particular second vibration threshold;
determining, based on the multiple second sets of time-series vibration data, that a vibration of the component of the particular wind turbine has exceeded the particular first vibration threshold;
generating a forecast of at least one of a period of time before the vibration of the component of the particular wind turbine may exceed the particular second vibration threshold and a future date at which the vibration of the component of the particular wind turbine may exceed the particular second vibration threshold;
generating an alert, the alert including the particular wind turbine and at least one of the period of time and the future date; and
providing the alert.

13. The method of claim 12, further comprising controlling, based on the alert, the particular wind turbine.

14. The method of claim 12 wherein each first set of time-series vibration data includes time-series vibration data for a period of time following a servicing of the component of the wind turbine of the multiple wind turbines.

15. The method of claim 14 wherein for each group of the multiple groups of wind turbines, defining, based on the subset of the multiple first sets of time-series vibration data for the components of the two or more wind turbines included in the group, the first vibration threshold and the second vibration threshold includes, for each group of the multiple groups of wind turbines, defining, based on a mean and a standard deviation of the subset of the multiple first sets of time-series vibration data for the components of the two or more wind turbines included in the group, the first vibration threshold.

16. The method of claim 12 wherein each first set of time-series vibration data includes time-series vibration data for a period of time prior to a servicing of the component of the wind turbine of the multiple wind turbines or a failure of the component of the wind turbine of the multiple wind turbines.

17. The method of claim 16 wherein for each group of the multiple groups of wind turbines, defining, based on the subset of the multiple first sets of time-series vibration data for the components of the two or more wind turbines included in the group, the first vibration threshold and the second vibration threshold includes, for each group of the multiple groups of wind turbines, defining, based on a mean of the subset of the multiple first sets of time-series vibration data for the period of time prior to the servicing of the component of the wind turbine of the multiple wind turbines or the failure of the component of the wind turbine of the multiple wind turbines for the components of the two or more wind turbines included in the group, the second vibration threshold.

18. The method of claim 12, further comprising:
determining, based on the multiple second sets of time-series vibration data, a trend for the vibration of the component of the particular wind turbine; and
determining an error for the vibration of the component of the particular wind turbine,
wherein generating the forecast of at least one of the period of time before the vibration of the component of the particular wind turbine may exceed the particular second vibration threshold and the future date at which the vibration of the component of the particular wind turbine may exceed the particular second vibration threshold includes generating, based on the trend of the vibration for the particular wind turbine and the error for the vibration of the component of the particular wind turbine, the forecast of at least one of the period of time before the vibration of the component of the particular wind turbine may exceed the particular second vibration threshold and the future date at which the vibration of the component of the particular wind turbine may exceed the particular second vibration threshold.

19. The method of claim 18, further comprising determining, based on the multiple first sets of time-series vibration data for the multiple wind turbines, at least one of periodic changes and short-term changes in vibrations of the components of the multiple wind turbines,
wherein generating the forecast of at least one of the period of time before the vibration of the component of the particular wind turbine may exceed the particular second vibration threshold and the future date at which the vibration of the component of the particular wind turbine may exceed the particular second vibration threshold further includes generating, based on at least one of the periodic changes and the short-term changes in vibrations of the components of the multiple wind turbines, the forecast of at least one of the period of time before the vibration of the component of the particular wind turbine may exceed the particular second vibration threshold and the future date at which the vibration of the component of the particular wind turbine may exceed the particular second vibration threshold.

20. The method of claim 12 wherein defining, based on the multiple first sets of time-series vibration data, the multiple groups of wind turbines of the multiple wind turbines, includes defining, based on mean, one or more standard deviations, and one or more percentiles of the multiple first sets of time-series vibration data, the multiple groups of wind turbines of the multiple wind turbines.

21. The method of claim 12, further comprising generating, based on the multiple first sets of time-series vibration data, multiple multidimensional features for the multiple wind turbines based on mean, one or more standard deviations, and one or more percentiles of the multiple first sets of time-series vibration data,
wherein defining, based on the multiple first sets of time-series vibration data, the multiple groups of wind turbines of the multiple wind turbines, includes:
clustering the multiple wind turbines, based on the multiple multidimensional features for the multiple wind turbines, to obtain multiple clusters of wind turbines, each cluster including two or more wind turbines of the multiple wind turbines; and
creating the multiple groups of wind turbines of the multiple wind turbines based on the multiple clusters of wind turbines.

22. The method of claim 12, further comprising:
receiving an indication that a servicing of the component of the particular wind turbine has been performed;
receiving multiple third sets of time-series vibration data for the particular wind turbine, each third set of time-series vibration data for the component of the particular wind turbine; and
based on the multiple third sets of time-series vibration data, placing the particular wind turbine in a group different from the particular group that included the particular wind turbine prior to the servicing of the component of the particular wind turbine.

23. A system comprising at least one processor and memory containing executable instructions, the executable instructions being executable by the at least one processor to:
receive multiple first sets of time-series vibration data for multiple wind turbines, each first set of time-series vibration data for a component of a wind turbine of the multiple wind turbines;
define, based on the multiple first sets of time-series vibration data, multiple groups of wind turbines of the multiple wind turbines, each group including two or more wind turbines of the multiple wind turbines;
for each group of the multiple groups of wind turbines, define, based on a subset of the multiple first sets of time-series vibration data for the components of the two or more wind turbines included in the group, a first vibration threshold and a second vibration threshold;
receive multiple second sets of time-series vibration data for a particular wind turbine of the multiple wind turbines, each second set of time-series vibration of the component of the particular wind turbine;
identify a particular group that includes the particular wind turbine;
identify, based on the particular group, a particular first vibration threshold and a particular second vibration threshold;
determine, based on the multiple second sets of time-series vibration data, that a vibration of the component of the particular wind turbine has exceeded the particular first vibration threshold;
generate a forecast of at least one of a period of time before the vibration of the component of the particular wind turbine may exceed the particular second vibration threshold and a future date at which the vibration of the component of the particular wind turbine may exceed the particular second vibration threshold;
generate an alert, the alert including the particular wind turbine and at least one of the period of time and the future date; and
provide the alert.

24. The system of claim 23, the executable instructions being further executable by the at least one processor to control, based on the alert, the particular wind turbine.
